(19) United States
(12) Patent Application Publication
(10) Pub. No.: US 2014/0364079 A1
(43) Pub. Date: Dec. 11, 2014

(54) METHOD AND APPARATUS FOR ADVANCED TOPOLOGY (AT) POLICY MANAGEMENT FOR DIRECT COMMUNICATION BETWEEN WIRELESS TRANSMIT/RECEIVE UNITS (WTRUs)

(71) Applicant: INTERDIGITAL PATENT HOLDINGS, INC., Wilmington, DE (US)

(72) Inventors: Robert A. DiFazio, Greenlawn, NY (US); Gregory S. Sternberg, Mt. Laurel, NJ (US); Balaji Raghothaman, Chester Springs, PA (US); Ravikumar V. Pragada, Collegeville, PA (US); Tao Deng, Roslyn, NY (US)

(73) Assignee: INTERDIGITAL PATENT HOLDINGS, INC., Wilmington, DE (US)

(21) Appl. No.: 14/363,672

(22) PCT Filed: Dec. 7, 2012
(86) PCT No.: PCT/US2012/068507

§ 371 Date: Jun. 6, 2014

Related U.S. Application Data
(60) Provisional application No. 61/568,388, filed on Dec. 8, 2011.

(51) Int. Cl. H04W 8/22; H04W 36/22; H04W 12/02; H04W 4/02

(52) U.S. Cl. CPC H04W 8/22; H04W 4/02; H04W 36/22; H04W 12/02
USPC 455/404.1; 455/418; 455/410

(57) ABSTRACT

A method and apparatus for advanced topology (AT) policy management for direct communication between wireless transmit/receive units (WTRUs) is described. A WTRU configured to communicate directly with at least one other WTRU in an AT mode of operation includes a memory, a central processing unit and an AT policy unit that is separate from the CPU. The AT policy unit is configured to store at least one AT policy in the memory, activate and de-activate an AT application that runs the AT mode of operation based on the at least one AT policy stored in the memory, receive data from at least one application within the WTRU other than the AT application, and control the at least one application within the WTRU other than the AT application based on the at least one AT policy stored in the memory.

### CROSS REFERENCE TO RELATED APPLICATIONS

This application claims the benefit of U.S. Provisional Patent Application No. 61/568,388, which was filed on Dec. 8, 2011, and PCT application No. PCT/US2012/068507, filed on Dec. 7, 2012, the contents of which are hereby incorporated by reference herein.

### BACKGROUND

Long Term Evolution-Advanced (LTE-A) supports a decode-and-forward relaying scheme. Proposed LTE-A decode-and-forward relay nodes receive data from a first device, demodulate, decode and error correct the data, and then re-transmit a new signal to a second device. This is different from a traditional repeater, for example, which simply receives and re-broadcasts a signal received from another device. The decode-and-relaying scheme, while more complex, may enhance signal quality over re-broadcasting, which may degrade signal quality from reduced signal-to-noise ratio (SNR).

Two major types of LTE-A decode-and-forward relays have been proposed. Type-1 relays control their own cells with their own identity. In other words, from the perspective of a wireless transmit/receive unit (WTRU), a type-1 relay appears to be a normal enhanced NodeB (eNB). From the perspective of a donor eNB, however, a type-1 relay appears to be a normal WTRU, but may identify itself as a relay via subsequent signaling. Type-2 relays, on the other hand, do not have their own cell identity and appear to WTRUs and eNBs as the main eNB in the cell.

The backhaul link between a type-1 relay node and a donor eNB and each access link between the type-1 relay node and each WTRU have their own full Layer-2 stacks, including full medium access control (MAC), radio link control (RLC) and packet data control protocol (PDCP) layers, all of which are terminated at the donor eNB, the relay node and the WTRU whose data is being relayed (“terminal WTRU”). Due to, for example, the relative complexity of the type-1 decode-and-forward relay nodes proposed for LTE-A, these nodes may be more powerful than WTRUs and are most likely stationary.

### SUMMARY

A method and apparatus for advanced topology (AT) policy management for direct communication between wireless transmit/receive units (WTRUs) is described. In an embodiment, a WTRU that is configured to communicate directly with at least one other WTRU in an AT mode of operation includes a memory, a central processing unit (CPU) and an AT policy unit that is separate from the CPU. The AT policy unit is configured to store at least one AT policy in the memory, activate and de-activate an AT application that runs the AT mode of operation based on the at least one AT policy stored in the memory, receive data from at least one application within the WTRU other than the AT application, and control the at least one application within the WTRU other than the AT application based on the at least one AT policy stored in the memory.

### BRIEF DESCRIPTION OF THE DRAWINGS

A more detailed understanding may be had from the following description, given by way of example in conjunction with the accompanying drawings wherein:

FIG. 1A is a system diagram of an example communications system in which one or more disclosed embodiments may be implemented;

FIG. 1B is a system diagram of an example wireless transmit/receive unit (WTRU) that may be used within the communications system illustrated in FIG. 1A;

FIG. 1C is a system diagram of an example radio access network and an example core network that may be used within the communications system illustrated in FIG. 1A;

FIG. 2 is a system diagram of an LTE-A relay system;

FIG. 3 is a diagram of an example cross link (XL) physical layer (PHY) frame structure;

FIGS. 4A, 4B, 4C and 4D are diagrams of example channel mappings between logical, transport and physical channels on the XL;

FIG. 5 is a diagram of an example WTRU policy agent;

FIG. 6 is a signal diagram of a method of communicating AT policies to a WTRU during WTRU attachment;

FIG. 7 is a signal diagram of methods of a WTRU obtaining AT policies using a push method and a pull method;

FIG. 8 is a flow diagram of a method of disabling AT-functionality based on AT policies for helper WTRUs in CONNECTED mode;

FIG. 9 is a flow diagram of a method of disabling AT-functionality based on AT policies for helper WTRUs in IDLE mode;

FIG. 10 is a flow diagram of a method of cell selection based on an example cell selection policy;

FIG. 11 is a flow diagram of a method of cell selection/re-selection based on another example cell selection policy;

FIG. 12 is a flow diagram of a method of a WTRU implementing an AT-Barred application policy;

FIG. 13 is a block diagram of an example access network discovery service function (ANDSF) that acts a repository for AT policies;

FIG. 14 is a block diagram of a policy architecture with subscriber profile repository (SPR); and

FIG. 15 is a block diagram of a system architecture with inclusion of a machine-to-machine server that stores AT policies.

### DETAILED DESCRIPTION

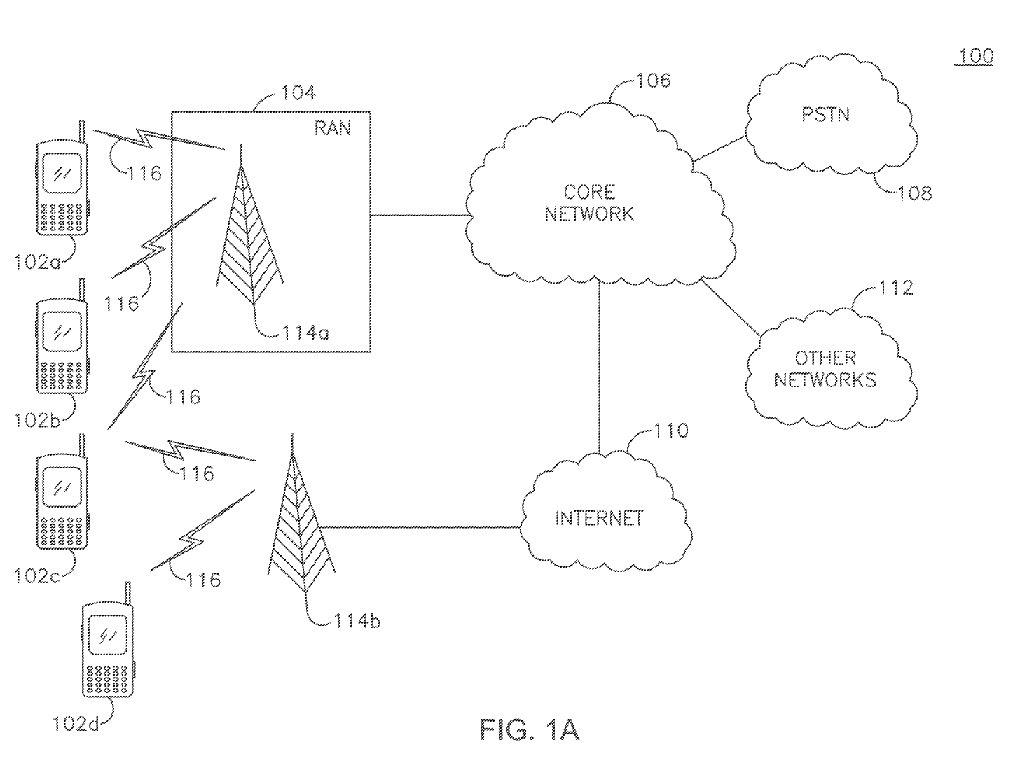

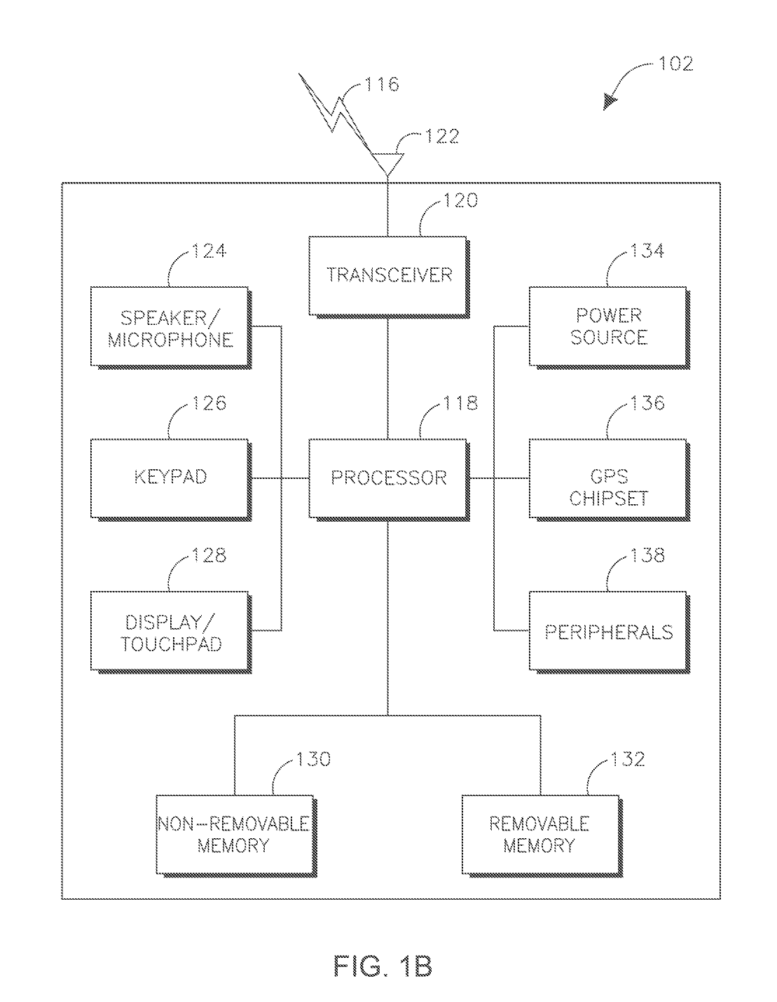

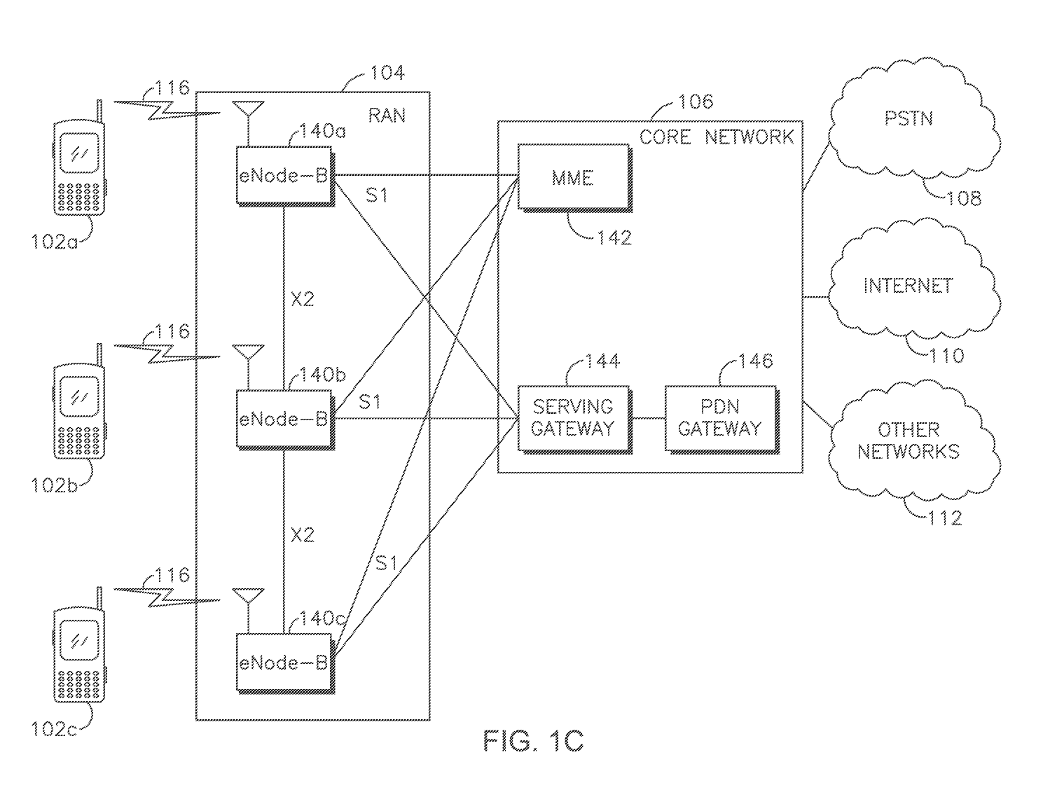

FIG. 1A is a diagram of an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 1A, the communications system 100 may include wireless transmit/receive units (WTRUs) 102a, 102b, 102c, 102d, a radio access network (RAN) 104, a core network 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications systems 100 may also include a base station 114a and a base station 114b. Each of the base stations 114a, 114b may be any type of device configured to wirelessly interface with at least one of the WTRUs 102a, 102b, 102c, 102d to facilitate access to one or more communication networks, such as the core network 106, the Internet 110, and/or the networks 112. By way of example, the base stations 114a, 114b may be a base transceiver station (BTS), a Node-B, an eNode B, a Home Node B, a Home eNode B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, etc. The base station 114a and/or the base station 114b may be configured to transmit and/or receive wireless signals within a particular geographic region, which may be referred to as a cell (not shown). The cell may further be divided into cell sectors. For example, the cell associated with the base station 114a may be divided into three sectors. Thus, in one embodiment, the base station 114a may include three transceivers, i.e., one for each sector of the cell. In another embodiment, the base station 114a may employ multiple-input multiple output (MIMO) technology and, therefore, may utilize multiple transceivers for each sector of the cell.

The base stations 114a, 114b may communicate with one or more of the WTRUs 102a, 102b, 102c, 102d over an air interface 116, which may be any suitable wireless communication link (e.g., radio frequency (RF), microwave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A).

In other embodiments, the base station 114a and the WTRUs 102a, 102b, 102c may implement radio technologies such as IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, and the like. In one embodiment, the base station 114b and the WTRUs 102c, 102d may implement a radio technology such as IEEE 802.11 to establish a wireless local area network (WLAN). In another embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, etc.) to establish a picocell or femtocell. As shown in FIG. 1A, the base station 114b may have a direct connection to the Internet 110. Thus, the base station 114b may not be required to access the Internet 110 via the core network 106.

The RAN 104 may be in communication with the core network 106, which may be any type of network configured to provide voice, data, applications, and/or voice over internet protocol (VoIP) services to one or more of the WTRUs 102a, 102b, 102c, 102d. For example, the core network 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the core network 106 may be in direct or indirect communication with other RANs that employ the same RAT as the RAN 104 or a different RAT. For example, in addition to being connected to the RAN 104, which may be utilizing an E-UTRA radio technology, the core network 106 may also be in communication with another RAN (not shown) employing a GSM radio technology.

The core network 106 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 104 or a different RAT.

Some or all of the WTRUs 102a, 102b, 102c, 102d in the communications system 100 may include multi-mode capabilities, i.e., the WTRUs 102a, 102b, 102c, 102d may include multiple transceivers for communicating with different wireless networks over different wireless links. For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram of an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and other peripherals 138. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In another embodiment, the transmit/receive element 122 may be an emitter/detector configured to transmit and/or receive IR, UV, or visible light signals, for example. In yet another embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 1C is a system diagram of the RAN 104 and the core network 106 according to an embodiment. As noted above, the RAN 104 may employ an E-UTRA radio technology to communicate with the WTRUs 102a, 102b, 102c over the air interface 116. The RAN 104 may also be in communication with the core network 106.

The RAN 104 may include eNode-Bs 140a, 140b, 140c, though it will be appreciated that the RAN 104 may include any number of eNode-Bs while remaining consistent with an embodiment. The eNode-Bs 140a, 140b, 140c may each include one or more transceivers for communicating with the WTRUs 102a, 102b, 102c over the air interface 116. In one embodiment, the eNode-Bs 140a, 140b, 140c may implement MIMO technology. Thus, the eNode-B 140a, for example, may use multiple antennas to transmit wireless signals to, and receive wireless signals from, the WTRU 102a.

Each of the eNode-Bs 140a, 140b, 140c may be associated with a particular cell (not shown) and may be configured to handle radio resource management decisions, handover decisions, scheduling of users in the uplink and/or downlink, and the like. As shown in FIG. 1C, the eNode-Bs 140a, 140b, 140c may communicate with one another over an X2 interface.

The core network 106 shown in FIG. 1C may include a mobility management gateway (MME) 142, a serving gateway 144, and a packet data network (PDN) gateway 146. While each of the foregoing elements are depicted as part of the core network 106, it will be appreciated that any one of these elements may be owned and/or operated by an entity other than the core network operator.

The MME 142 may be connected to each of the eNode-Bs 142a, 142b, 142c in the RAN 104 via an S1 interface and may serve as a control node. For example, the MME 142 may be responsible for authenticating users of the WTRUs 102a, 102b, 102c, bearer activation/deactivation, selecting a particular serving gateway during an initial attach of the WTRUs 102a, 102b, 102c, and the like. The MME 142 may also provide a control plane function for switching between the RAN 104 and other RANs (not shown) that employ other radio technologies, such as GSM or WCDMA.

The serving gateway 144 may be connected to each of the eNode Bs 140a, 140b, 140c in the RAN 104 via the S1 interface. The serving gateway 144 may generally route and forward user data packets to/from the WTRUs 102a, 102b, 102c. The serving gateway 144 may also perform other functions, such as anchoring user planes during inter-eNode B handovers, triggering paging when downlink data is available for the WTRUs 102a, 102b, 102c, managing and storing contexts of the WTRUs 102a, 102b, 102c, and the like.

The serving gateway 144 may also be connected to the PDN gateway 146, which may provide the WTRUs 102a, 102b, 102c with access to packet-switched networks, such as the Internet 110, to facilitate communications between the WTRUs 102a, 102b, 102c and IP-enabled devices.

The core network 106 may facilitate communications with other networks. For example, the core network 106 may provide the WTRUs 102a, 102b, 102c with access to circuit-switched networks, such as the PSTN 108, to facilitate communications between the WTRUs 102a, 102b, 102c and traditional land-line communications devices. For example, the core network 106 may include, or may communicate with, an IP gateway (e.g., an IP multimedia subsystem (IMS) server) that serves as an interface between the core network 106 and the PSTN 108. In addition, the core network 106 may provide the WTRUs 102a, 102b, 102c with access to the networks 112, which may include other wired or wireless networks that are owned and/or operated by other service providers.

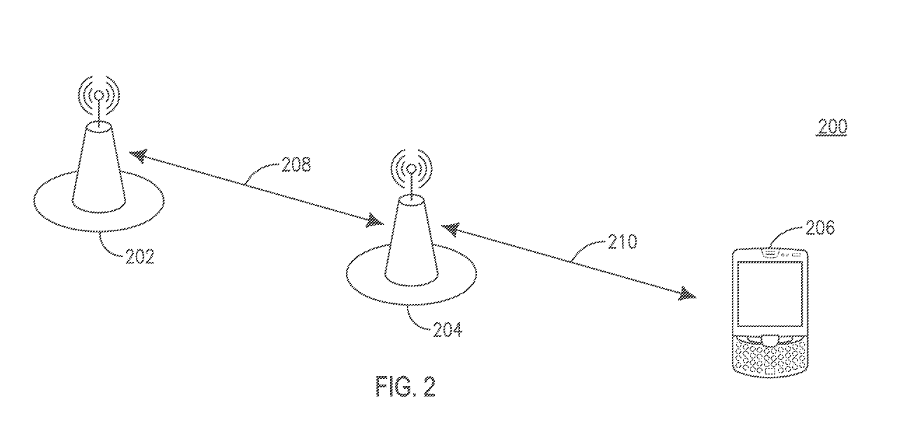

FIG. 2 is a system diagram of an LTE-A relay system 200. The illustrated LTE-A relay system includes a donor cell 202, a relay node 204 and a terminal WTRU 206. The donor cell 202 and the relay node 204 communicate with one another over a backhaul link 208. The relay node 204 and the terminal WTRU 206 communicate with one another over an access link 210. The relay node 204 may be configured to relay PDCP service data units (SDUs) between the donor cell 202 and the terminal WTRU 206. The backhaul link 208 and the access link 210 may operate completely independently of one another.

In contrast to the type-1 relay nodes described above that make use of high power, stationary relay nodes, embodiments of an advanced topology (AT) network are described herein that make use of direct WTRU-to-WTRU communication to relay data between a network and a terminal WTRU (“AT-relay” or “AT-R”) or to transfer data between WTRUs (“AT-local offload” or “AT-LO”). For example, in an embodiment, a smart phone may be configured to function as a mini infrastructure node in addition to its primary roles to operate in an AT-R and/or AT-LO mode. In AT-R embodiments, a terminal WTRU may exchange data with the network through another WTRU referred to as a helper WTRU. In AT-R, any WTRU may act as a terminal WTRU or a helper WTRU at different times and data may be relayed between the terminal WTRU and an eNB using a two hop setup. In the two hop setup, the first hop may either be between the terminal WTRU and the helper WTRU or the eNB and the helper WTRU, and the second hop may be the hop not taken during the first hop, depending on whether the transmission is in the uplink (UL) or downlink (DL). In AT-LO embodiments, WTRUs in proximity to one another may engage in direct data communications with one another under control of a central network.

AT-R embodiments may be used to increase capacity (capacity mode or AT-RCap) and coverage (coverage mode or AT-RCov) in cellular systems. In AT-RCap, a helper WTRU may augment radio link capacity between existing WTRUs and a base station to enhance the capacity of the network and improve data transmission capacity. In AT-RCov, a helper WTRU may be used to provide coverage to WTRUs that are not in coverage and, therefore, do not have a link to the base station.

In AT-RCov for a baseline LTE cellular system, for example, a WTRU may be considered to be in coverage if it is registered with the network (e.g., it is in an EMM-REGISTERED state), it is able to decode the broadcast channel (BCH) from a suitable cell in the network and read the primary system information (SI), it is able to decode the paging channel (PCH) and read paging messages and secondary SI, it is able to reach the cell using a RACH procedure in IDLE mode or the PUCCH/PUSCH in CONNECTED mode, and it is able to transmit and receive certain minimum data rates over the PUSCH and the PDSCH, respectively. WTRUs that do not satisfy these conditions may be said to be out of coverage and may continue to go through cell reselection until they find a suitable cell. In the meantime, they may camp on any available cell for purposes of making emergency calls, but may not be page-able. In AT-RCov embodiments described herein, such an out-of-coverage WTRU (e.g., a potential terminal WTRU) may be provided coverage through a helper WTRU. In order to take advantage AT-RCov, however, the WTRU must still have network synchronization and timing.

In AT-LO embodiments, two close-by WTRUs may initiate a local off-load transmission under control of a central network. In an embodiment, a group of WTRUs in proximity may be assigned to a cluster with a cluster head designated by the network. In this embodiment, the cluster head may communicate directly with each cluster member and may be responsible for access control and radio resource management (RRM) of all cross links (XLs) between individual pairs of WTRUs in the cluster. Under coordination and control of the cluster head, the cluster members may apply direct WTRU-to-WTRU communication.

WTRU-to-WTRU communications may be applied to many real-world scenarios with significant potential benefits. For example, a user deep inside a building with very poor coverage may obtain coverage and additional capacity through a helper WTRU with good coverage situated at the periphery of the building or outside. For another example, users that are in close proximity and need to exchange data or have a voice conversation may do so directly without routing the data/voice through a base station and a core network. For example, co-workers in an office may have conversations and exchange data in this manner. Direct WTRU-to-WTRU communications may also enable applications related to social networking by providing information about other users belonging to the same social group that are in close proximity. It may also enable true wireless gaming experiences with extremely low latencies by connecting the users directly instead of being routed through a network. If multiple users are downloading similar information from a network, the network may transmit the data to a smaller subset of users, who may then relay the data to the other end users. For example, users in a stadium who wish to see the instant replay of an event on the field may fall under this category. Users who are in different vehicles traveling along a highway may form direct links and transmit information to each other. One potential application may be to have instantaneous communication of accidents/traffic bottlenecks relayed to vehicles farther behind on the same road so that they may take diversions.

In both AT-R and AT-LO embodiments, communication between WTRUs may occur in a dedicated channel referred to as a cross link (XL) as opposed to, for example, traditional eNB to WTRU communication that occurs over a traditional radio link (TRL). For AT-LO embodiments, the XL may be used for communications between a pair of WTRUs, and for AT-R embodiments, the XL may be used for communications between pairs of terminal WTRUs and helper WTRUs. In an embodiment, it may be assumed that the XL channels are sufficiently separated from the TRL such that no inter-carrier or adjacent channel interference occurs between the TRL and the XLs. In this embodiment, a separate radio frequency (RF) transceiver chain may be required for the XLs. However, in-band operation of the XL may also be possible. In an embodiment, the XL resources may be located out-of-band with respect to the TRL. The XL channel may use OFDM for its physical layer (PHY) multiplexing, similar to, for example, baseline LTE. The helper and terminal WTRUs may communicate with each other using FDD or time-division duplexing (TDD), and the related configuration may be defined by the network. In an embodiment, the network may provide coarse resource allocation for the XL, and the WTRUs (e.g., one or both of the helper WTRU and the terminal WTRU) may have the freedom to handle the per-TTI resource allocation.

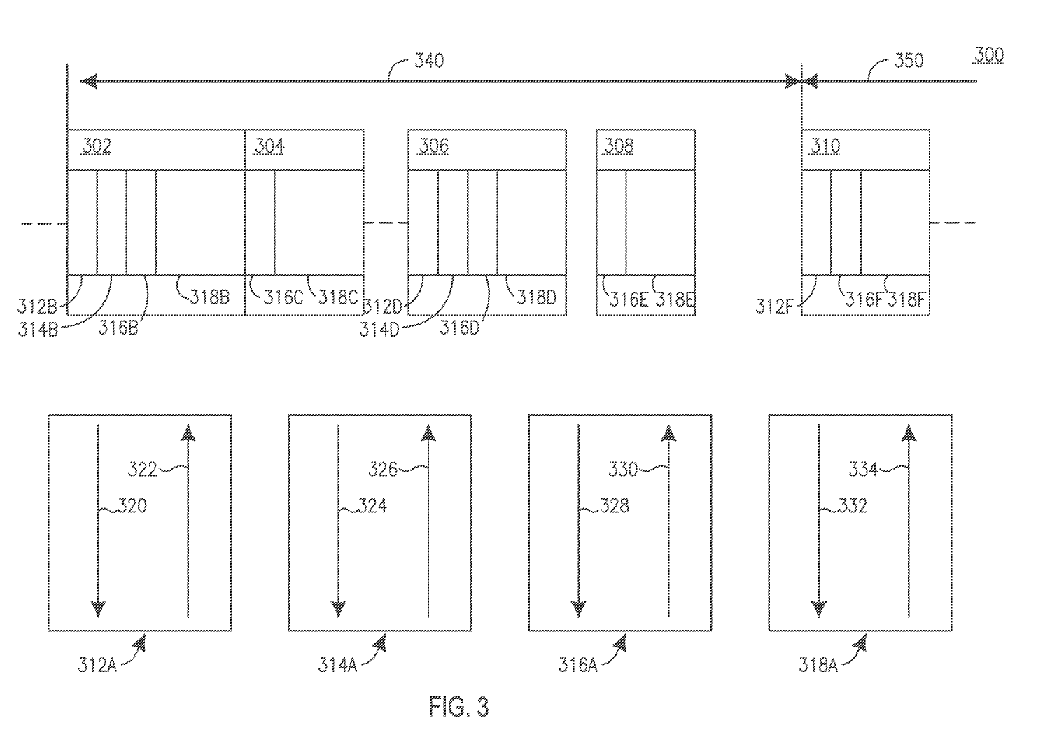

FIG. 3 is a diagram of an example XL PHY frame structure 300. In the example illustrated in FIG. 3, the XL PHY frame structure includes a number of frames (e.g., 340 and 350) and corresponding subframes (e.g., 302, 304, 306, 308 and 310). The subframes 302, 304, 306, 308 and 310 include a number of different zones, including a neighbor discovery zone 312, an unscheduled control zone 314, a normal control zone 316 and a data zone 318.

The neighbor discovery zone 312 occurs twice in every frame, once in each direction, or based on network configuration. For example, frame 340 includes an occurrence 312b of the neighbor discovery zone 312 in subframe 302 and an occurrence 312d of the neighbor discovery zone 312 in subframe 306. Only one subframe 310 of frame 350 is illustrated in FIG. 3, and subframe 310 includes an occurrence 312f of the neighbor discovery zone 312. However, frame 350 includes additional subframes (not shown), and one of the additional subframes may include an additional occurrence of the neighbor discovery zone. During a neighbor discovery zone (e.g., 312a), a WTRU may transmit a neighbor discovery initiation transmission (NDIT) 322 and await a neighbor discovery response transmission (NDRT) 320.

Within each subframe (e.g., 302, 304, 306, 308 and 310), the time-frequency resources may be divided into an unscheduled control zone (UCZ) 314, a normal control zone (NCZ) 316 and a data zone (DZ) 318. In an alternative embodiment (not shown), the neighbor discovery zone may be considered part of the subframe structure, in which case the subframe may also be considered to be the same direction as the neighbor discovery zone (e.g., transmit or receive).

The UCZ 314 includes a predetermined set of resources that may occur in every frame (once in each direction) or in certain frames that may be calculated based on the cell system frame number (SFN) (e.g., based on network configuration). Thus, all XLs in a cell may have a UCZ in the same frame. For example, frame 340 includes an occurrence 314b of the UCZ 314 in subframe 302 and an occurrence 314d of the UCZ 314 in subframe 306. Only one subframe 310 of frame 350 is illustrated in FIG. 3, and it does not include an occurrence of the UCZ. However, frame 350 includes additional subframes (not shown), and some of the additional subframes may include an occurrence of the UCZ.

In the example illustrated in FIG. 3, a neighbor seeking WTRU may use the UCZ 314a to transmit to a neighbor present WTRU an indication that it has been selected by the neighbor seeking WTRU as the prospective helper WTRU (“helper WTRU select message”) (326). The UCZ may also be used by the neighbor present WTRU to transmit basic system information to a neighbor seeking WTRU to enable association formation (324). The transmissions may occur prior to association formation and may potentially be transmitted without scheduling resources from the eNB. Thus, multiple neighbor present WTRUs may be transmitting basic system information in the same UCZ, which may provide a diversity benefit. Helper WTRU select messages from multiple neighbor seeking WTRUs may overlap in the same WTRU but may be separated using, for example, PHY scrambling mechanisms.

The NCZ 316 occurs in every subframe. In the example illustrated in FIG. 3, each of the subframes 302, 304, 306, 308 and 310 includes a respective NCZ occurrence 316b, 316c, 316d, 316e and 316f. Only one subframe 310 of frame 350 is illustrated in FIG. 3. However, frame 350 includes additional subframes (not shown), which may each include an occurrence of the NCZ. Further, in the example illustrated in FIG. 3, the NCZ (e.g., 316a) may be used for transmission of the XL physical DL control channel (XPDCCH) 328, the XL physical UL control channel (XPUCCH) 330, keep-alive messages and association messages.

The DZ 318 occurs in every subframe within a frame. In the example illustrated in FIG. 3, each of the subframes 302, 304, 306, 308 and 310 includes a respective DZ 318b, 318c, 318d, 318e and 318f. Only one subframe 310 of frame 350 is illustrated in FIG. 3. However, frame 350 includes additional subframes (not shown), which may each include an occurrence of the DZ as well. The DZ (e.g., DZ 318a) may be used to transmit data transport blocks (TBs) between the WTRUs, for example, on the cross link DL (XDL) shared channel (XPDSCH) 332 and the XUL shared channel (XPUSCH) 334. DZs may also include reference signals that may enable the WTRUs to make measurements of the XL.

For AT-R embodiments, the XL may include a number of physical channels in the XDL and the XUL. The XDL is the radio access link from the helper WTRU to the terminal WTRU. It applies to the helper WTRU and the terminal WTRU and operates in the XL frequency band. The XUL is the radio access link from the terminal WTRU to the helper WTRU. It applies to the helper WTRU and the terminal WTRU and operates in the XL frequency band. The XDL physical channels may include, for example, the XL physical neighbor discovery channel (XPNDCH), the XL physical DL association channel (XPDACH), the XL physical DL shared access channel (XPDSACH), the XL physical grant channel (XPGCH), the XL physical DL feedback channel (XPDFBCH), the XL physical DL data channel (XPDDCH) and the XL physical DL control channel (XPDCCH). The XUL physical channels may include, for example, the XL physical neighbor discovery channel (XPNDCH), the XL physical UL association channel (XPUACH), the XL physical UL shared access channel (XPUSACH), the XL physical UL feedback channel (XPUFBCH), the XL physical UL data channel (XPUDCH) and the XL physical UL control channel (XPUCCH). The XUL may also carry reference signals including, for example, an XL specific reference signal and a keep alive signal. In an embodiment, the XL physical channels are presumed to be OFDM based.

The XPNDCH may carry sequences used for neighbor discovery transmissions, including neighbor discovery initiation transmissions (NDITs) and neighbor discovery response transmissions (NDRTs). In an embodiment, the XPNDCH may occupy a default and pre-defined symbol and sub-carrier resource location that is not subject to XL grants or scheduling. The XPNDCH may apply code division multiple access (CDMA), and the code configuration may be derived by a WTRU, for example, according to pre-defined algorithms. When the XL bandwidth is more than the default frequency resource, the network may allocate additional resources (e.g., sub-carriers) for the channel in order to increase the neighbor discovery capacity.

The XPDACH may carry PHY control information, including, for example, paging indicators, association transmit/receive (TX/RX) indicators or XL grant (XLG) indicators. In an embodiment, the XPDACH may occupy a default and pre-defined symbol location, which may not be subject to XL grants (XLGs) or scheduling. The XPDACH may apply frequency division multiple access (FDMA) and/or CDMA, and the configuration may be derived by a WTRU based on the code configuration of its preceding associated XPNDCH.

The XPUACH may carry PHY control information, including, for example, XL scheduling requests (XSRs) and XL measurement result indicators. In an embodiment, the XPUACH may occupy a default and pre-defined symbol location, which may not be subject to XLG and scheduling. The XPUACH may apply FDMA and/or CDMA, and the configuration may be derived by a WTRU based on the code configuration of its preceding associated XPNDCH.

The XPDSACH may carry higher layer control information, including, for example, basic system information (BSI), initial configuration information (InitConfiguration) (including XLG) and selected helper WTRU information. In an embodiment, the XPDSACH may occupy a default and pre-defined symbol location, which may not be subject to XL grants or scheduling. The XPDSACH may apply FDMA and/or CDMA, and the configuration may be derived by a WTRU based on the configuration of its associated XPDACH. In an embodiment, the information necessary to decode the channel, such as transport format, may be pre-defined.

The XPUSACH may carry higher layer control information, including, for example, XL measurement results. In an embodiment, the XPUSACH may occupy a default and pre-defined symbol location, which may not be subject to XLGs or scheduling. The XPUSACH may apply FDMA and/or CDMA, and the configuration may be derived by a WTRU based on the configuration of its associated XPUACH. In an embodiment, the information necessary to decode the channel, such as transport format, may be pre-defined.

The XPGCH may carry XLG information, including, for example, sub-carrier allocation, TDD sub-frame duplex scheme, maximum XL power, dedicated XL channel code configuration and reference signal configuration. In an embodiment, the XPGCH may occupy a default and pre-defined symbol location, which may not be subject to XLGs or scheduling. The XPGCH may apply FDMA and/or CDMA, and the configuration may be derived by a WTRU based on the configuration of its associated XPDACH. This unscheduled version of the XPGCH may exist only in AT-R coverage mode. In both AT-R capacity and coverage modes, the XLG for the helper WTRU may also specify the complete resource configuration of this channel for XL dedicated use of XLG transmission from helper WTRU to terminal WTRU, and in that case, the XPGCH may apply space, time, frequency or code division multiple access. In an embodiment, this channel may be only applied on the XDL.

The XPDFBCH may carry channel state information (CSI) of the XUL and the ACK/NACK of the XUL data transmission. In an embodiment, the complete resource allocation of this channel may be determined by the XLG for the helper WTRU. The XDFBCH may apply space, time, frequency or code division multiple access.

The XPDDCH may carry XDL user data received from the MAC layer. In an embodiment, the complete resource allocation of this channel may be determined by the XLG for the helper WTRU. The XPDDCH may apply space, time, frequency, or code division multiple access.

The XPDCCH may carry data related to control information for the terminal WTRU to decode the XPDDCH in the same TTI. In an embodiment, the complete resource allocation of this channel may be determined by the XLG for the helper WTRU. The XPDCCH may apply space, time, frequency, or code division multiple access.

The XPUFBCH may carry channel state information of the XDL and the ACK/NACK of the XDL data transmission. In an embodiment, the complete resource allocation of this channel may be determined by the XLG for the terminal WTRU. The XUFBCH may apply space, time, frequency, or code division multiple access.

The XPUDCH may carry XUL user data received from the MAC layer. In an embodiment, the complete resource allocation of this channel may be determined by the XLG for the helper WTRU. The XPUDCH may apply space, time, frequency, or code division multiple access.

The XPUCCH may carry necessary control information for the helper WTRU to decode the XPUDCH correctly. In an embodiment, the complete resource allocation of this channel may be determined by the XLG for the terminal WTRU. The XPUCCH may apply space, time, frequency, or code division multiple access.

The MAC layer may provide services to the RLC in the form of logical channels. The type of logical channel may be either a control channel used for transmission of control and configuration information or a traffic channel used for carrying the user data. The XL logical channels may include an XL physical control channel (XPCCH), an XL common control channel (XCCCH), an XL dedicated control channel (XDCCH) and an XL dedicated traffic channel (DTCH).

The PHY may offer services to the MAC in the form of transport channels, and the XL transport channels may include an XL paging channel (XPCH), an XL common channel (XCCH), an XDL scheduling channel (XDL-SCH) and an XUL scheduling channel (XUL-SCH). Data on a transport channel may be organized into transport blocks, and, in an embodiment, one transport block of a certain size may be transmitted in each TTI. For embodiments employing special multiplexing (e.g., MIMO), up to two transport blocks may be transmitted in one TTI.

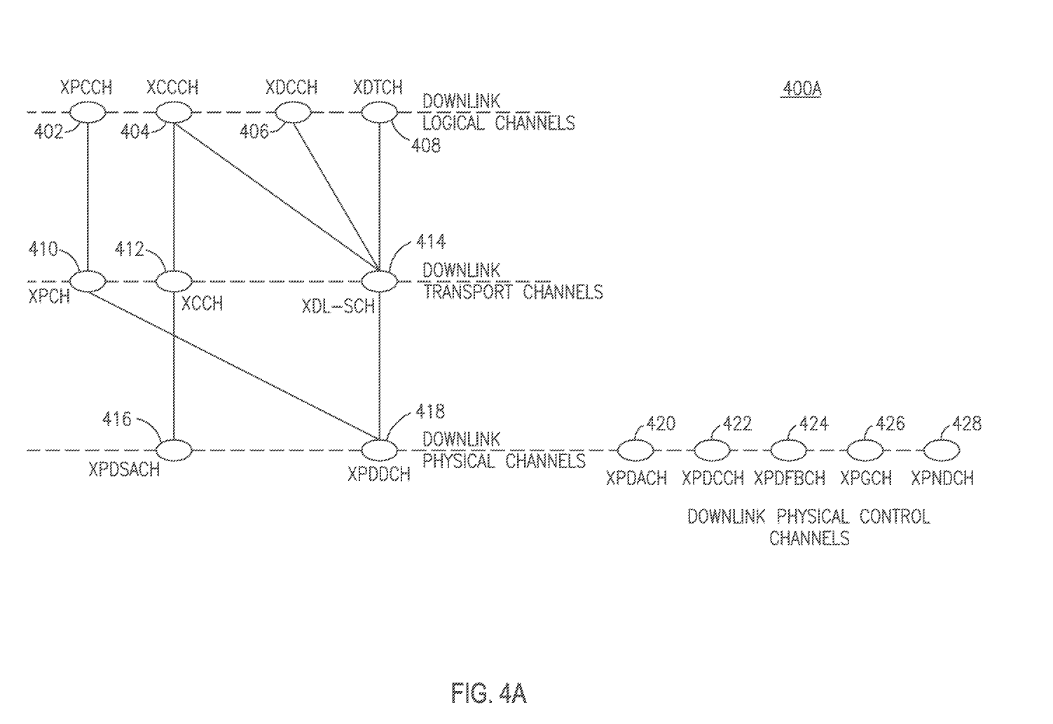

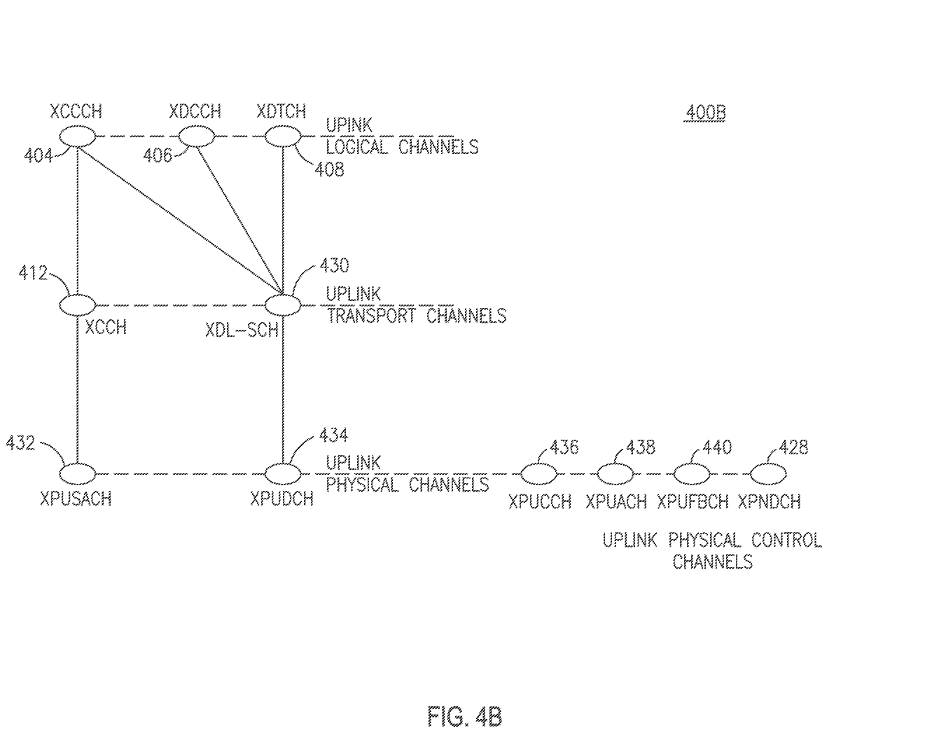

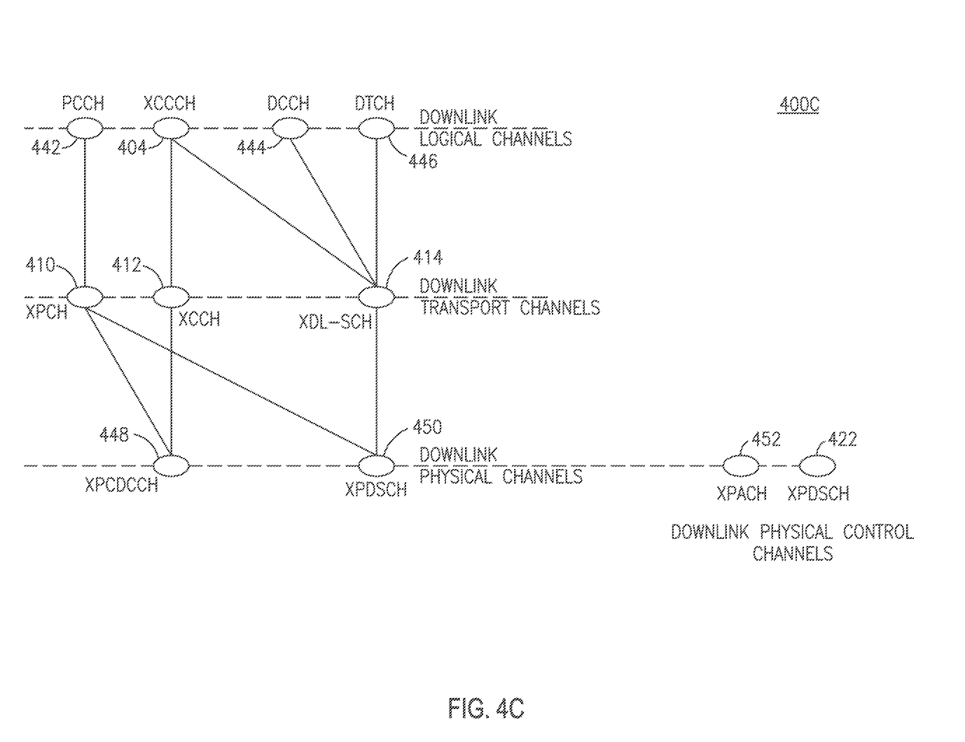

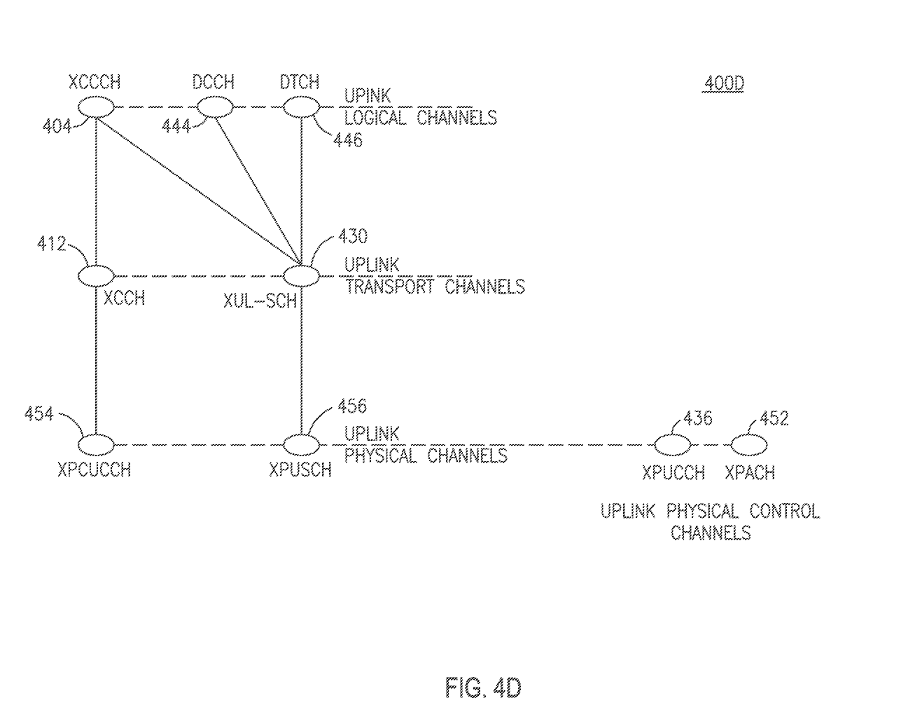

FIGS. 4A, 4B, 4C and 4D are diagrams of example channel mappings between logical, transport and physical channels on the XL.

FIG. 4A is an example channel mapping 400a for an XDL. In the example illustrated in FIG. 4A, mappings for the XPCCH 402, XCCCH 404, XDCCH 406 and XDTCH 408 DL logical channels, the XPCH 410, XCCH 412 and XDL-SCH 414 DL transport channels and the XPDSACH 416, XPDDCH 418, XPDACH 420, XPDCCH 422, XPDFBCH 424, XPGCH 426 and XPNDCH 428 DL physical channels are shown. FIG. 4B is an example channel mapping 400b for an XUL. In the example illustrated in FIG. 4B, mappings for the XCCCH 404, XDCCH 406 and XDTCH 408 UL logical channels, XCCH 412 and XUL-SCH 430 UL transport channels and XPUSACH 432, XPUDCH 434, XPUCCH 436, XPUACH 438, XPUFBCH 440 AND XPNDCH 428 UL physical channels are shown. FIG. 4C is an example channel mapping 400c for an XDL. In the example illustrated in FIG. 4C, mappings for the PCCH 442, XCCCH 404, DCCH 444 and DTCH 446 DL logical channels, XPCH 410, XCCH 412 and XDL-SCH 414 DL transport channels and XPCDCCH 448, XPDSCH 450, XPACH 452 and XPDCCH 422 DL physical channels are shown. FIG. 4D is an example channel mapping 400d for an XUL. In the example illustrated in FIG. 4D, mappings for the XCCCH 404, DCCH 444 and DTCH 446 UL logical channels, XCCH 412 and XUL-SCH 430 UL transport channels and XPUCCH 454, XPUSCH 456, XPUCCH 436 and XPACH 452 UL physical channels are shown.

Since AT applications require use of helper WTRU resources, it may be desirable to have a robust set of policies to govern and aid their deployment. In some embodiments, such policies may enable individual operators to tailor the use of direct WTRU-to-WTRU communications in a manner that optimizes different parts of their network as per local requirements. Embodiments are described below that provide different WTRU and/or network policies for governing the use of AT applications, for example, at a helper WTRU. Architecture for maintaining a policy database and applying the policies is also described. In an example, a WTRU AT policy agent may store AT policies at the WTRU, receive and manage policy updates, receive inputs from other WTRU systems and control such other WTRU systems to apply the policies. Examples of AT policies that are described herein include policies for setting a mode of AT operation (e.g., coverage, capacity, network offload or any combination thereof), enabling or disabling AT operations based on status of the WTRU's battery, assertion of user preference or cell loading in the network, policies governing handling of emergency call features during AT operation, policies governing cell selection/re-selection in an AT mode of operation, policies governing handling of sensitive applications that are barred from being relayed through other WTRUs in an AT mode, policies governing handling of legal intercept in an AT mode, modifications to the charging function as it may apply to AT operations, changes to radio parameters and other parameters based on an AT mode and policies governing priority status of the WTRU.

AT policies may be implemented at a WTRU (e.g., a helper WTRU) through a WTRU policy unit. The WTRU policy entity may be a clearing house for all AT policy related aspects, including, for example, maintaining the AT policies in the WTRU, updating such policies based on network command or internal triggers, accepting information from various WTRU modules, providing policy commands directing the WTRU modem and other WTRU modules to alter their behavior based on the received inputs and providing updates to various modem parameters.

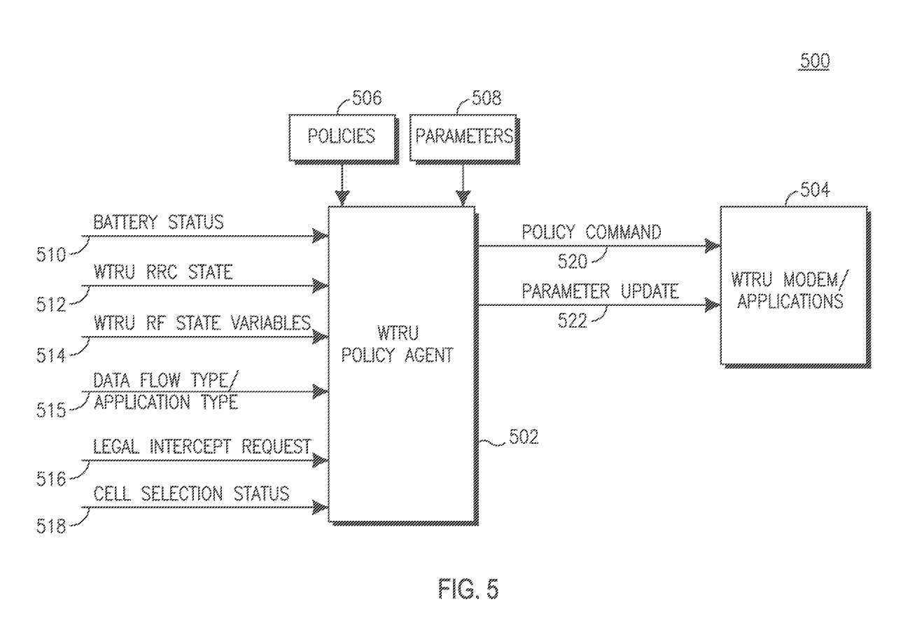

FIG. 5 is a diagram 500 of a WTRU policy agent 502. The WTRU policy agent 502 may be a WTRU policy unit and may be configured to receive information from other entities, either inside or outside of the WTRU. In the example illustrated in FIG. 5, the WTRU is configured to receive a battery status 510 from a battery and/or power management function in the WTRU, a WTRU radio resource control (RRC) state 512 from a WTRU modem implementation, WTRU radio frequency (RF) state variables 514 (e.g., transmit power), the current application and data flow type 515 from the WTRU's application layer, legal intercept requests 516, cell selection statuses 518, policies 506 and parameters 508. The WTRU policy agent 502 may store the policies and related updates in a memory in the WTRU. Based on, for example, the stored policies and other received information, the WTRU policy agent 502 may issue control commands 520 and/or provide parameter updates 522 to a WTRU modem and/or other WTRU applications and modules 504. Accordingly, the WTRU policy agent 502 may control the WTRU modem and other WTRU applications in order to enforce the most current AT policies at the WTRU.

As described above, the WTRU policy agent 502 may be configured to store AT policies and related updates in the WTRU. Such policies may be stored, for example, in the persistent memory areas of the WTRU or in a removable memory such as a universal mobile telecommunications subscriber identification module (USIM).

Further, in an embodiment, the network may autonomously send AT policies 506 to the WTRUs (e.g., a push model) or provide them to the WTRUs upon request (e.g., a pull model). For USIM applications, AT policies may be communicated to WTRUs using, for example, over-the-air (OTA) procedures or OTA updates using Open Mobile Alliance-Device Management (OMA-DM). For other embodiments, AT policies may be communicated to WTRUs using a user data convergence (UDC) update procedure. The UDC may provide a secure front end through which the WTRU may access network databases without compromising their security. For other embodiments, AT policies may be communicated to WTRUs as part of a WTRU initial attach.

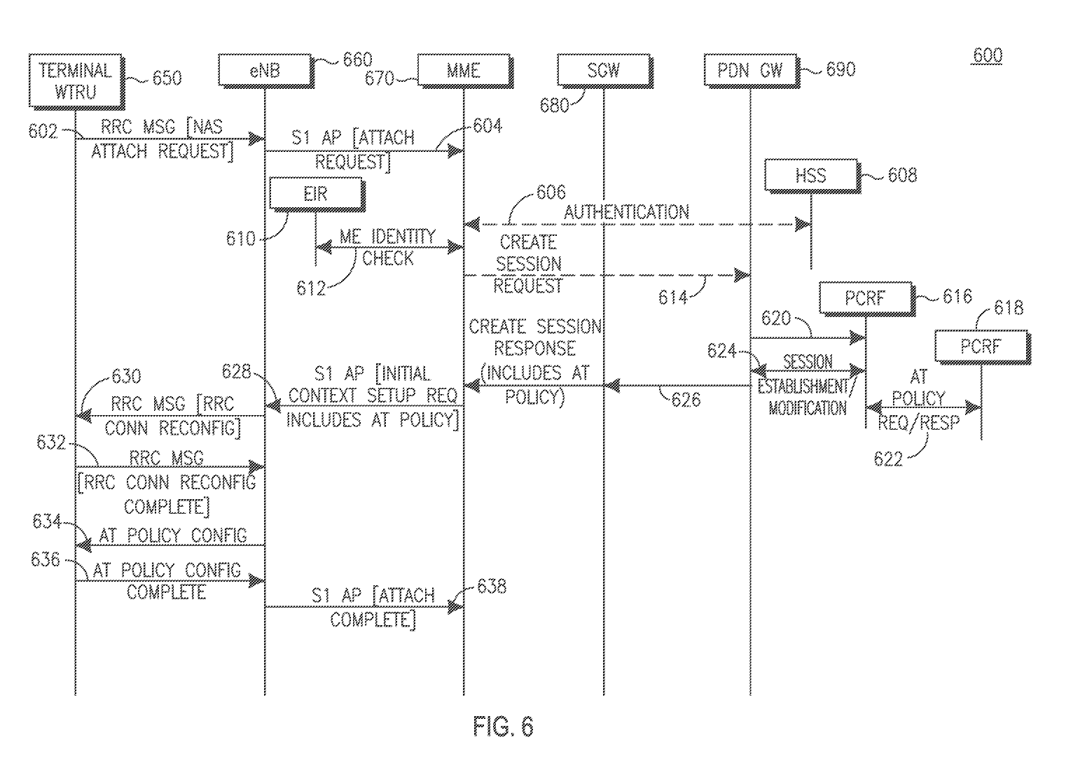

FIG. 6 is a signal diagram 600 of a method of communicating AT policies to a WTRU during WTRU attachment. In the example illustrated in FIG. 6, a WTRU 650 initiates an attachment to a network by sending an ATTACH request 602 to an enhanced node-B (eNB) 660. Other signaling in the ATTACH procedure may depend on the type of network(s) involved. In the illustrated example, the eNB 660 forwards the ATTACH request to a mobile management entity (MME) 670 (604), and an equipment identity register (EIR) 610 may simultaneously perform an identity check (612). An authentication procedure may then be carried out between the MME 670, a serving gateway (SGW) 680, a packet data network gateway (PDN GW) 690 and a home subscriber server (HSS) 608 (606). The MME 670 may also send a create session request message 614 to the PDN GW 690 via the SGW 680.

During the initial attach procedure, based on knowledge of the AT capability of the WTRU 650, a policy and charging rules function 616 (the entity responsible for overall policy management in the network) may request and receive AT policies from an AT policy server 618 (622) in response to receiving a session establishment/modification message 620 from the PDN GW 690. These policies may then be pushed down to the eNB 660 as part of the initial context information. In the illustrated example, the policies are pushed down to the MME 670 (624/626), which sends a create session response message 627 to the MME 670, including the AT policies in the message 627. Finally, the MME 670 may send the policies to the eNB 660 in its initial context setup request 628.

The policies may then be pushed down to the WTRU 650 as a new RRC message called an AT Policy Config message 630. The WTRU 650 may respond to the AT Policy Config message with an AT Policy Config Complete message 636. The WTRU 650 and the eNB 660 may complete the ATTACH procedure by the WTRU 650 sending an RRC Conn Reconfig message to the eNB 660 and the eNB 660 responding with an RRC Con Reconfig Complete message 634. When the procedure is complete, the eNB 660 may send an ATTACH complete message 638 to the MME 670 signaling completion of the procedure.

In addition to policy download during an initial attach procedure, a WTRU may also obtain the policy updates at any other time. For example, the WTRU may obtain the policies by a push from the network or by pulling the policies itself.

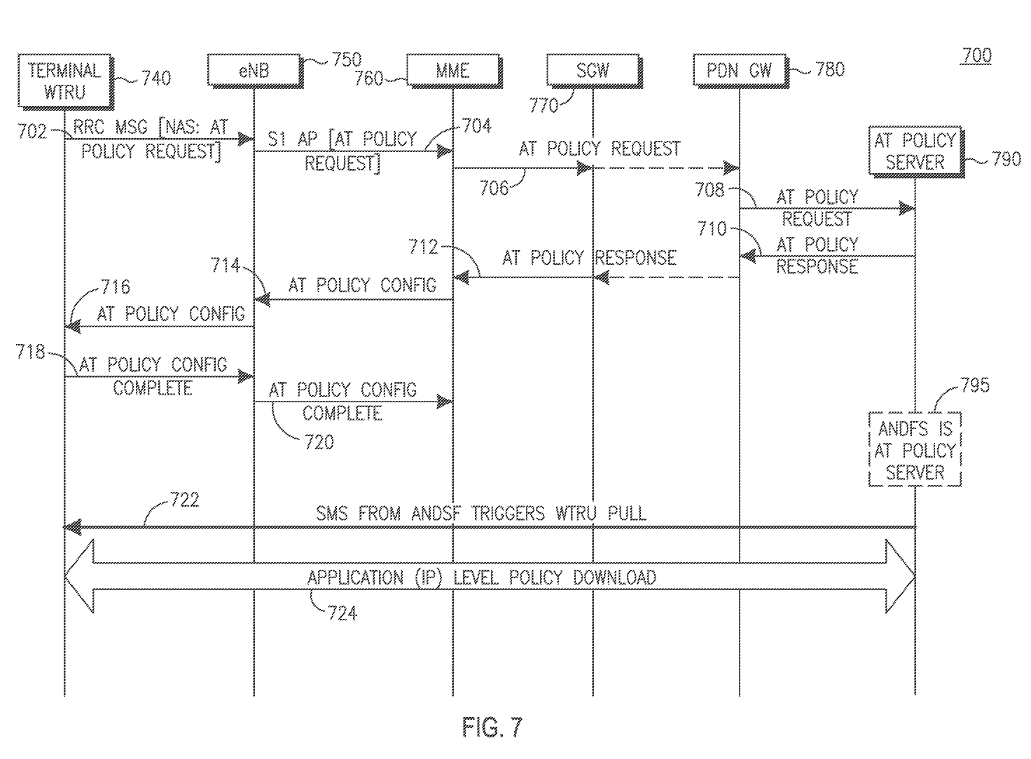

FIG. 7 is a signal diagram 700 of methods of a WTRU obtaining AT policies using a push method and a pull method. The policy updates may be performed using a network access server (NAS) procedure or through an application layer procedure directly between the WTRU and the AT policy server, such as the access network discovery and selection function.

In an example pull NAS procedure illustrated in FIG. 7, a WTRU 740 may send an NAS AT policy request RRC message 702 to an eNB 750. The AT policy request message may be forwarded to an AT policy server 790 (708) via an MME 760 (704), an SGW 770 and PDN GW 780 (706). The AT policy server 790 may respond with an AT policy response message (710) including either the policy or policies requested in the AT policy request message or a denial or the request. The AT policy request message may be forwarded to the MME 760 via the SGW 770 (712). The MME 760 may then send AT policy configurations to the eNB 750 via an AT Policy Config message (714), which the eNB 750 may forward to the WTRU 740 that initially sent the request (716). In response to receiving the AT Policy Config message from the eNB 750, the WTRU 740 may send an AT Policy Config Complete message to the eNB 750 (718), which may forward it to the MME 760 (720).

In the example push procedure illustrated in FIG. 7, an access network discovery service function (ANDSF) AT Policy Server 795 may push the policies to the WTRU 740 by sending a trigger to the WTRU (722). In an embodiment, the trigger may take the form of an SMS message. The WTRU 740 and the ANDSF AT policy server 795 may then engage in an application (IP) level policy download procedure 724 by which the WTRU 740 may download any necessary policies.

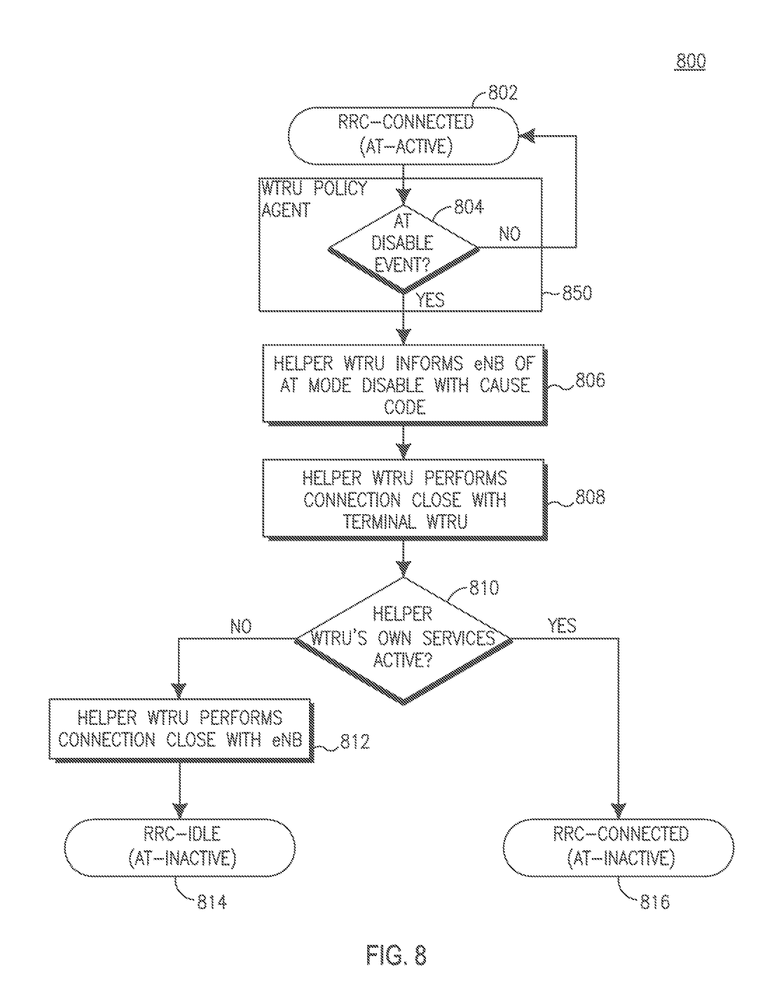

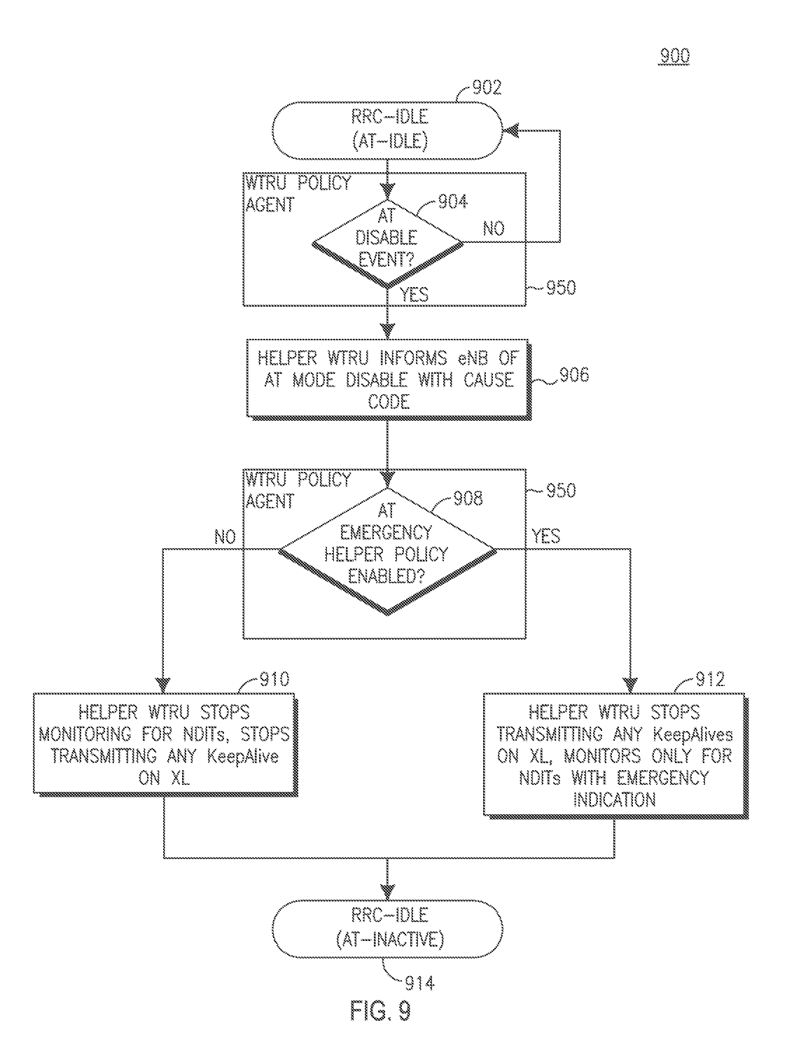

FIGS. 8 and 9 are flow diagrams of methods of disabling AT-functionality based on AT policies.

FIG. 8 is a flow diagram 800 of a method of disabling AT-functionality based on AT policies for helper WTRUs in CONNECTED mode. In the example illustrated in FIG. 8, the WTRU is initially in RRC_CONNECTED mode and AT functionalities are active (802). A WTRU policy agent 850 may determine whether an AT disable event has occurred (804). Example disable events are described in more detail with respect to examples of specific AT policies below, and may include, for example, battery life<AT_Threshold % or a user preference is asserted. If an AT disable event has not occurred, the WTRU policy agent 850 may wait until an AT disable event occurs. If an AT disable event has occurred, the WTRU policy agent 850 at a helper WTRU may inform an eNB that it is disabling one or more of its AT functionalities/modes and include a code indicating the reason why the one or more functionalities have been disabled (806). If the helper WTRU is providing AT services to a terminal WTRU at the time that a disable event occurs, the WTRU policy agent 806 at the helper WTRU may perform a connection close procedure with the terminal WTRU (808). The WTRU may then determine whether the helper WTRU's own services are still active (810). If so, the WTRU may remain in RRC_CONNECTED mode with AT functionalities inactive (816). If not, the WTRU may perform a connection close procedure with the eNB (812) and enter an RRC_IDLE state with AT functionalities inactive (818).

FIG. 9 is a flow diagram 900 of a method of disabling AT-functionality based on AT policies for helper WTRUs in IDLE mode. In the embodiment illustrated in FIG. 9, the WTRU is initially in RRC_IDLE mode and AT functionalities are idle (AT-Idle mode) (902). A WTRU policy agent 950 may determine whether an AT disable event has occurred (904). Example disable events are described in more detail with respect to examples of specific AT policies below, and may include, for example, battery life<AT_Threshold % or a user preference is asserted. If an AT disable event has not occurred, the WTRU policy agent 950 may wait until an AT disable event occurs. If an AT disable event has occurred, the WTRU policy agent 950 at a helper WTRU may inform the eNB that it is disabling one or more of its AT functionalities/modes and include a code indicating the reason why the one or more functionalities have been disabled (906). The WTRU policy agent 950 may also determine whether an AT emergency helper policy is enabled in the WTRU (908). If so, the WTRU may stop transmitting any keep alive messages on the XL and monitor only for NDITs with an emergency indication (912). If not, the WTRU may stop monitoring for NDITs and stop transmitting any keep alive messages on the XL (910). In both scenarios, the WTRU may remain in RRC_IDLE mode with AT functionalities inactive (914) unless there is some other reason for the WTRU to transition to RRC_ACTIVE mode.

One example AT policy may be a mode of AT-R operation policy. This policy may control the AT configurations that a WTRU is allowed to assume (e.g., one or both of the capacity mode and the coverage mode). The AT-R operation policy may be a network-wide policy that may be signaled to WTRUs in a network in, for example, system information (SI).

Another example AT policy may be a battery life policy. One concern with respect to the practical deployment of AT-R is the penalty paid by a helper WTRU in terms of their battery consumption. Accordingly, a policy that may be implemented may include a policy that the WTRU disable its AT functionality if its battery life drops below a threshold value AT_Threshold %. In an embodiment, a threshold may be provided for emergency calls from terminal WTRUs. In this example, a prospective helper WTRU may agree to be the helper WTRU for a terminal WTRU without coverage if the terminal WTRU is trying to make an emergency call, even if the helper WTRU's battery life is below the threshold. The policy may also ensure that the WTRU enable its AT functionality if a WTRU is connected to an alternating current (AC) power source. A WTRU with its AT functionality disabled may re-enable it when its battery life rises above another threshold value AT_Threshold2%. A battery life policy may be either a network policy that is conveyed to the WTRU or a WTRU policy that may be modifiable, for example, according to user preferences.

Policies may also be put into effect that govern user preferences for enabling/disabling AT functionality. Most current network designs mandate the behavior of a WTRU through network control. However, other embodiments may be possible where some user control is allowed with respect to the AT-R and AT-LO architecture. For example, a complete user control policy may be put in effect where a user may disable a WTRU's AT-R and/or AT-R functionality whenever he or she prefers by using a connection manager configuration or other user input. The AT functionality may remain disabled until the user manually re-enables it. For another example, a partial user control policy may be put into effect where a user may disable the AT-R and/or AT-LO functionality, but a network may re-enable it for any one of a number of different reasons. For example, the network may re-enable user-disabled AT functionality after a configurable period of time following the disable request from the user elapses, when the WTRU is power cycled, when there are specific types of network broadcasts (e.g., Earthquake and Tsunami Warning system broadcasts), or for OTA software upgrades.

Another example user preference policy may provide for no user control. Under this policy, a user may have no ability to control the AT-R behavior of a WTRU. Another example user preference policy may provide for conditional user disable of AT functionality. In this example, a user may set various conditions under which the AT-R mode will be disabled. Examples of such conditions may include, for example, if the battery life of a helper WTRU falls below a level determined by the policy or if the helper WTRU is performing a data-and-resource-intensive operation, such as video download or upload. With respect to both examples, a user may disable AT-R functionality if either condition is met. In an embodiment, the user may also be given a preference with respect to battery level. Another example user preference policy may provide for priority access status of a user.

Another example AT policy may be an emergency call policy. In an embodiment, an emergency call policy may govern whether an AT-capable WTRU provides coverage to another WTRU for emergency call purposes even if its AT-R coverage mode is temporarily disabled. For a policy wherein the WTRU will provide coverage for emergency call purposes when its AT-R coverage mode is temporarily disabled, the WTRU participates in neighbor discovery and listens for neighbor discovery initiation transmissions even if its AT-R mode is disabled. However, the WTRU responds only if it receives a neighbor discovery initiation transmission for an emergency call. Such a policy may also require that a discovery sequence (e.g., a neighbor discovery initiation transmission (NDIT) sequence from a WTRU seeking to make an emergency call also convey the cause.

Another example AT policy may be a cell loading policy. When a cell is very lightly loaded, the traffic demands of users may be met without the need for WTRU relays, and the incremental approval obtained using AT-R may not justify the additional battery drain on the helper WTRUs. Accordingly, in an embodiment, a network may disable capacity mode AT-R functionality in all the AT-capable devices in the network if the cell loading falls below a threshold AT_CellLoadThreshold_Parameter %. In another embodiment, the network may disable capacity mode AT-R functionality if the cell is heavily loaded and it does not want to accept any new AT users. Here, the network may enable AT-RCap functionality in AT-capable devices if its cell loading rises above a threshold AT_CellThreshold2_Parameter % in order to improve its performance under loading and to alleviate its capacity bottleneck. Cell load based enable-disable may be a network-based policy, and the implementation may be in the form of broadcast of an AT-enable/disable bit as part of the system information in the cell.

Closed subscriber group (CSG) policies may also be implemented. In an embodiment, a WTRU that sees a CSG cell during cell selection/reselection may compares a CSG identifier (CSGID) of the CSG cell with an allowed CSG list and an operator CSG list stored locally and make a determination as to whether it is allowed to camp on the cell and use its services. A network may also have CSG subscription data for each user. For AT-enabled WTRUs, a neighbor seeking WTRU may not be able to distinguish between a helper WTRU camped on a regular cell and a helper WTRU camped on a CSG cell. Accordingly, an AT policy may be used to govern whether an AT-capable WTRU camping on a CSG cell may provide AT services to other WTRUs that are not authorized to use the cell (e.g., WTRUs that do not have the CSGID of the cell in their CSGID list). In this example, a neighbor seeking WTRU may find a CSG-camped helper WTRU in neighbor discovery but may not be able to complete the association formation, and, therefore, would need to go back to cell reselection and neighbor discovery. However, an exception may be made when a potential terminal WTRU is attempting to make an emergency call, in which case the neighbor seeking WTRU may complete the association and help with an emergency call, even if the neighbor seeking WTRU does not belong to its CSG. In an embodiment, the neighbor seeking WTRU may indicate that it needs to make an emergency call as part of its association formation and/or neighbor discovery.

Cell selection policies may also be implemented. In a base cell selection/reselection procedure, if a WTRU is not in coverage or is camped in a lower priority cell or in any cell state, it may be required to perform cell reselection at periodic intervals to find the most suitable cell to camp on. In an embodiment, a WTRU in any cell state may be required to search each higher layer at least once every 60*Nlayers seconds, where Nlayers is the number of higher priority frequencies. For AT-R coverage mode, the WTRU may be required to perform neighbor discovery operations, which may also consume a certain period of time depending on, for example, the neighbor discovery system frame number (NDSFN) cycle length or availability of nearby helper WTRUs. If a terminal WTRU has a separate radio for an out-of-band XL, then the terminal WTRU may perform neighbor discovery on the XL simultaneously with cell selection/reselection on the TRL.

With respect to cell reselection, a WTRU policy may be established wherein a neighbor discovery process may begin after a specified number of layers of cell search are performed but before all of the possible cell searches are exhausted. For example, a WTRU policy may be to attempt neighbor discovery after searching for cells in the same PLMN but before searching for roaming cells. Another aspect of such a policy may be to specify how long after finding a neighbor present WTRU a neighbor seeking WTRU will continue attempting to find a more suitable cell before initiating an association formation with the discovered neighbor.

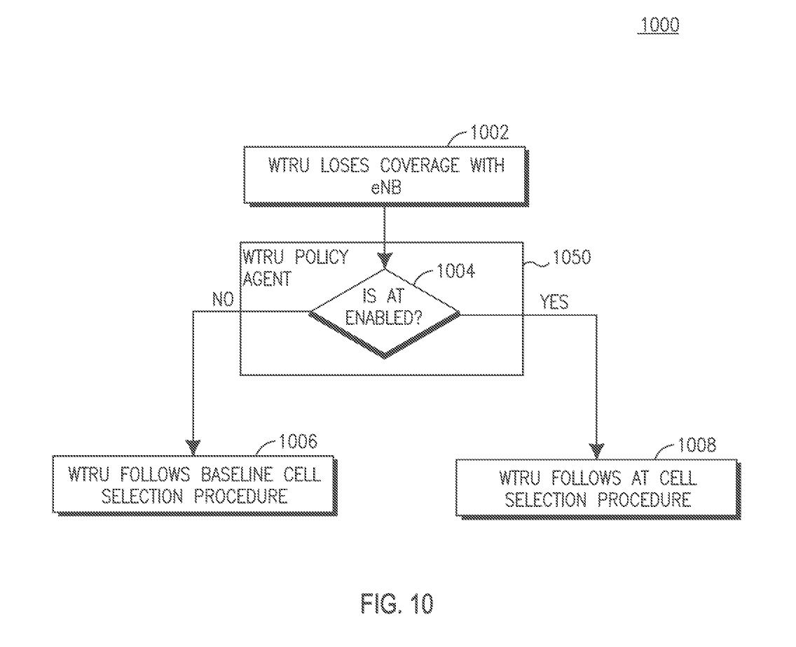

FIG. 10 is a flow diagram 1000 of a method of cell selection based on an example cell selection policy. In the example illustrated in FIG. 10, a WTRU loses coverage with an eNB (1002). A policy agent 1050 at the WTRU may determine whether AT is enabled (1004). On a condition that AT is enabled, the WTRU may follow an AT cell selection procedure to select and attach to a new eNB (1008). On a condition that AT is not enabled, the WTRU may follow a baseline cell selection procedure to select and attach to a new eNB (1006).

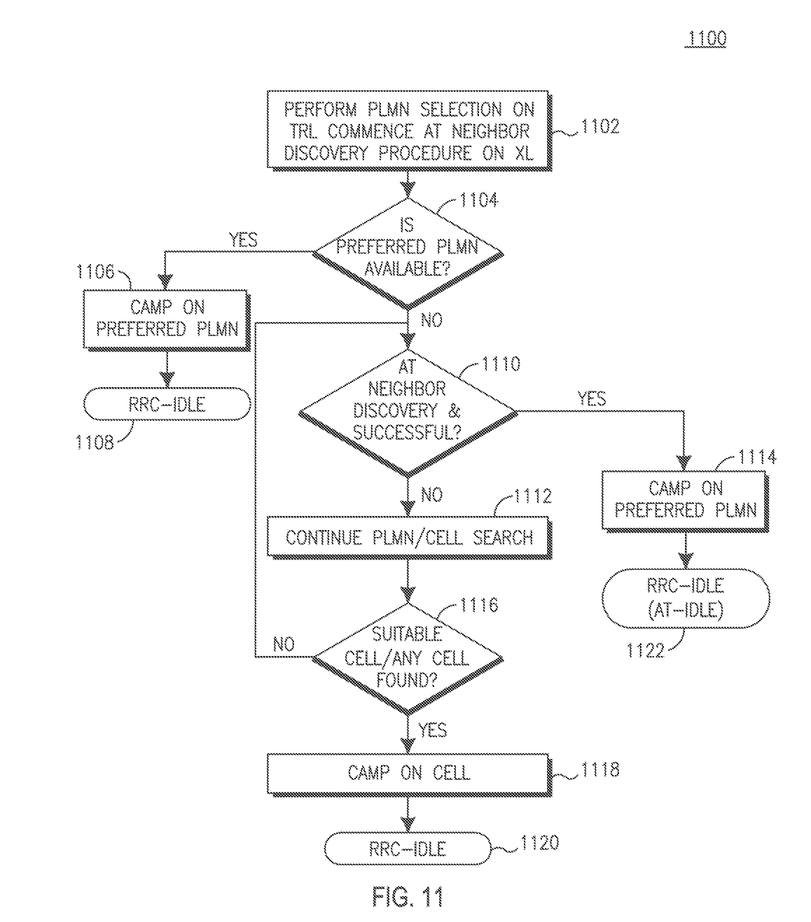

FIG. 11 is a flow diagram 1100 of a method of cell selection/re-selection based on another example cell selection policy. In the example illustrated in FIG. 11, a WTRU may perform public land mobile network (PLMN) selection on the TRL and begin an AT neighbor discovery procedure on the XL (1102). The WTRU may determine whether a preferred PLMN is available (1104). On a condition that a preferred PLMN is available, the WTRU may camp on the preferred PLMN (1106) and enter RRC_IDLE mode (1108). On a condition that a preferred PLMN is not available, the WTRU may determine whether AT neighbor discovery was successful (1110). On a condition that AT neighbor discovery was successful, the WTRU may perform association procedures (1114) and enter RRC_IDLE mode with AT functionalities idle (1122). On a condition that AT neighbor discovery was not successful, the WTRU may continue PLMN/cell search (1112) and then determine whether a suitable cell or any cell was found (1116). On a condition that a suitable cell (or any cell, depending on the policy) is available, the WTRU may camp on the cell (1118) and enter RRC_IDLE mode (1120).

Legal intercept policies may also be implemented. Lawful intercept is a requirement imposed by most governments that requires the operator to intercept and provide the content of a user's traffic on demand. This requirement may also need to be satisfied by systems employing direct WTRU-to-WTRU communication, either as relay or for local offload. In AT-R, the intercept function may be performed by the network as in baseline since the eNB is either the source/sink of the data transfer to/from the terminal WTRU. In the AT-LO mode, however, a policy may govern whether a lawful intercept request requires that the local traffic also be available at the controlling eNB(s). One way such a requirement may be satisfied for direct WTRU-to-WTRU applications is to have the lawful intercept request place a restriction on the routing of traffic such that all data passes through the network. Additionally, forwarding WTRUs may be enlisted as intercept points and may forward the local stream of data back to the network for capture and forwarding to the appropriate authorities. Such a policy may be a network policy.

Location services policies may also be implemented. Services that require location information may be impacted by the use of AT, particularly the coverage mode. In an embodiment, the helper WTRU's location may be used as a proxy for the terminal WTRU location. This may be feasible at least in some circumstances based on the accuracy requirements because the XL is meant to be a short range link. However, in such an embodiment, the helper WTRU must provide consent to use its location for the purposes of providing the terminal WTRU's services. In an embodiment, an AT policy variable that allows the helper WTRU to enable or disable the network's ability to use its location for such purposes may be implemented.

Charging policies may also be implemented. The charging function in the operator's network may be based on the amount of traffic that is carried to a particular user. This may not be affected in any significant manner for the AT-R system if the network does not count any relayed traffic towards the helper WTRU's data consumption totals. However, for the AT-LO mode of operation, additional policies may be required. Because the local traffic between WTRUs is carried over the operator owned spectrum in the embodiments of the AT-LO system described herein, it is likely that the operator would charge the users for the traffic. On the other hand, since AT-LO results in offloading traffic from the network (and may potentially reduce the required air interface resources), the operator may want to charge a differentiated rate for such traffic. Another example of such an approach may be the differentiated charging policy for home eNB (HeNB)/CSG cells. In order for such a charging policy to be implemented, WTRUs may have to report the amount of traffic sent or received by it per quality of service (QoS) class. The charging policies may be network policies.

Several parameters that may be used in an AT system deployment may also be considered part of the policy framework. Examples of such parameters may include transmit power of the neighbor discovery beacon, XL bandwidth/frequency, the system frame number (SFN) cycle length for neighbor discovery, the frequency at which neighbor lists are updated in connected mode, and triggers for neighbor discovery. With respect to the transmit power beacon, this parameter may determine the capture radius for the neighbor discovery process and may be broadcast by the eNB as part of the system information block (SIB). With respect to the frequency at which neighbor lists are updated in connected mode, this parameter may be dependent on the highest QoS that the WTRU is currently receiving. With respect to triggers for neighbor discovery, they may include, for example, the average UL transmit power for the WTRU to be able to reach the eNB beyond which the WTRU will trigger neighbor discovery, the propagation loss to the eNB being above a certain threshold, DL data throughput being below a certain threshold, suitability for helper function, the average UL transmit power required from the candidate helper WTRU to the eNB (he helper WTRU may be considered suitable below this threshold), and the average transmit power required for communication between a terminal WTRU and a helper WTRU (the helper WTRU may be considered suitable below this threshold). In an embodiment, some of these parameters may be provided to the WTRU as part of its policy while others may be signaled either in the SI or during connection configuration.

Security and privacy policies may also be implemented. Embodiments of a system design for a helper WTRU described herein may envision that only the MAC and a portion of the radio link control (RLC) stack are terminated at the helper WTRU. The end-to-end security between the eNB and the terminal WTRU may be maintained, and the terminal WTRU security keys are never provided to the helper WTRU. Accordingly, the helper WTRU is incapable of deciphering the data being communicated between the eNB and the terminal WTRU. However, there may be a possible breach in security when a helper WTRU relays a user's sensitive data, such as corporate e-mail. In an embodiment, a policy may be implemented wherein certain application data may be barred from being relayed through another WTRU.

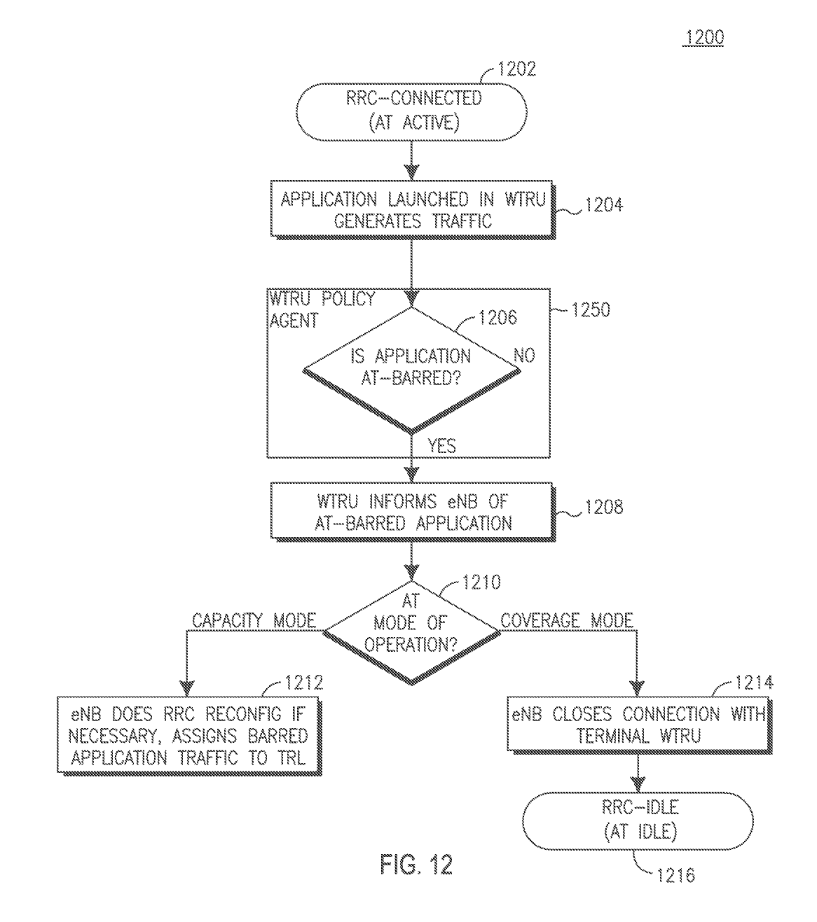

FIG. 12 is a flow diagram 1200 of a method of a WTRU implementing an AT-Barred application policy. In the example illustrated in FIG. 12, a WTRU is initially in an RRC_CONNECTED mode with AT functionalities active (1202). When an AT-Barred application is launched and generates traffic (1204), a policy agent 1250 at the WTRU may determine whether an application is AT-Barred (1206). On a condition that the application is AT-Barred, the WTRU may inform the eNB of the AT-Barred application (1208). The WTRU may also determine what AT mode of operation the WTRU is in (1210). On a condition that the WTRU is in capacity enhancement mode, the eNB may ensure that the data from the AT-Barred application is routed through the TRL only. Here, the eNB may perform RRC reconfiguration if necessary and assign barred application traffic to the TRL (1212). This may be possible since separate radio bearers may be established for the TRL and the XL communication between the terminal WTRU and the eNB. On a condition that the WTRU is in coverage mode, however, the eNB may desist from allocating any XL resources for the AT-Barred application data, and the WTRU may either close the application or await a change in status to a non-AT state or a capacity enhancement state before it may transfer the application data (1214). After the eNB closes its connection with the WTRU, the WTRU may be in an RRC_IDLE mode with AT functionalities idle (1216).

AT policy enforcement functionality may executed by a separate policy agent entity (e.g., an entity that is separate from the WTRU and/or the eNB or that is separate from the central processing unit within a WTRU) or may be part of an existing evolved packet system (EPS) network.

In an embodiment, an ANDSF may be used as a repository for AT policies. The role of the ANDSF is to aid the discovery of non-3GPP access networks (e.g., WiFi) by WTRUs that are also able to operate in non-3GPP networks.

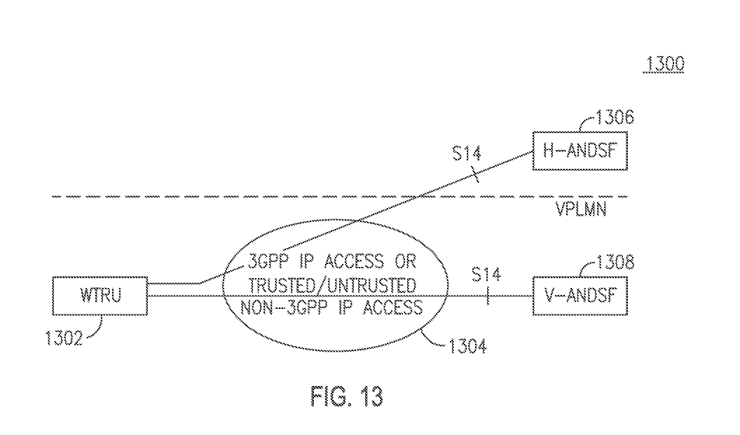

FIG. 13 is a block diagram of an example ANDSF that acts a repository for AT policies. In the example illustrated in FIG. 13, a WTRU 1302 is in communication with a home ANDSF (H-ANDSF) 1306 in a home PLMN (HPLMN) 1310 and a visited ANDSF (V-ANDSF) 1308 in a visited PLMN (VPLMN) 1312 via a 3GPP IP access or an un-trusted non-3GPP IP access network 1304. AT policies may be stored in either of the H-ANDSF 1306 or the V-ANDSF 1308, and the WTRU 1302 may obtain policies from one or both of those entities.

In another embodiment, a subscriber profile repository (SPR)/user data repository (UDR) may be used a repository for AT policies. The SPR is a functional entity that includes the user profile information for the network. The UDR is a functional entity that stores all of the data relevant to a user. Information that was previously stored in the SPR, home subscriber server (HSS) or authentication center (AuC) may have been consolidated into the UDR in the IMS architecture.

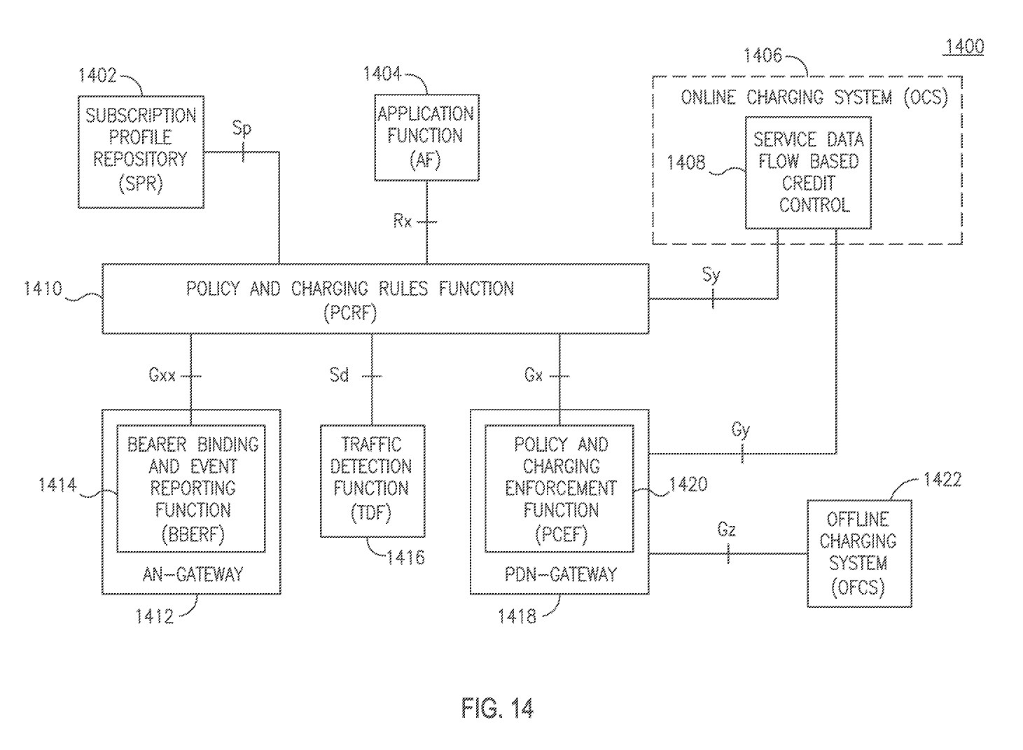

FIG. 14 is a block diagram 1400 of a policy architecture with SPR. In the example illustrated in FIG. 14, a PCRF 1410 is coupled to a number of different modules including the SPR 1402, the application function (AF) 1404, a service data flow based credit control unit 1408 of an online charging system (OCS) 1406, a policy and charging enforcement function (PCEF) 1420 of a PDN-GW 1418, a traffic detection function (TDF) and a bearer binding and event reporting function (BBERF) 1414 of an AN-Gateway 1412. The PDN-GW 1418 may also be coupled to an offline charging system (OFCS) 1422. In the illustrated example, AT policies may be stored in the SPR 1402 and accessed by the PCRF 1410 for communication to a WTRU (not shown).

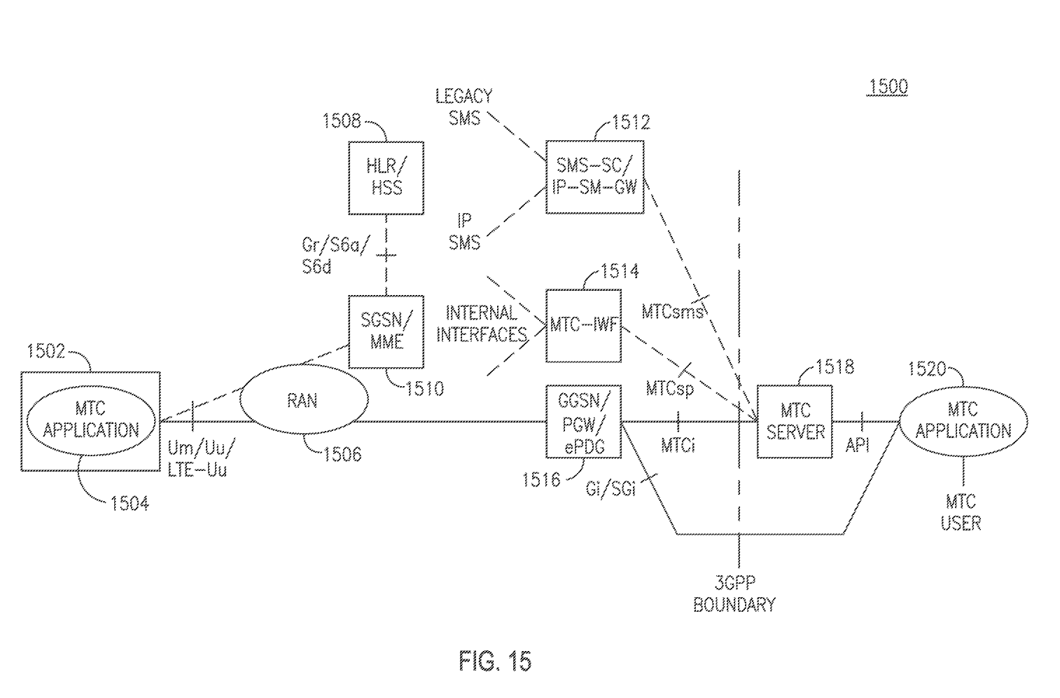

In another embodiment, AT policies may be located in an external server such as a machine type communication (MTC) server for machine-to-machine communications. FIG. 15 is a block diagram 1500 of a system architecture with inclusion of an MTC server that stores AT policies. In the example illustrated in FIG. 15, the system architecture includes an MTC application 1504 within a WTRU 1502 that is in communication with an MTC server 1518 via a radio access network (RAN) 1506. The RAN 1506 communicates with the MTC server 1518 via any of a number of different entities, including, for example, a home location register (HLR)/HSS 1508, an SGSN/MME 1510, an SMS-SC/IP-SM-GW 1512, an MTC-IWF 1514 and a GGSN/PGW/ePDG 1516. In an embodiment, the MTC server 1518 may store the AT policies and may also be in direct communication with another MTC application 1520. In the illustrated example, in typical applications, the MTC server 1518 is located outside of the 3GPP network boundary and, hence, outside of a typical network operator's control.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A wireless transmit/receive unit (WTRU) configured to communicate directly with at least one other WTRU in an advanced topology (AT) mode of operation comprising:
a memory;
a central processing unit (CPU); and
an AT policy unit that is separate from the CPU and is configured to:
receive an at least one AT policy from a network entity;
store the at least one AT policy in the memory;
activate and de-activate an AT application that runs the AT mode of operation based on the at least one AT policy stored in the memory,
receive data from at least one application within the WTRU other than the AT application, and
control the at least one application within the WTRU other than the AT application based on the at least one AT policy stored in the memory.

2. The WTRU of claim 1, wherein the AT mode of operation is an AT relay (AT-R) mode of operation in which the WTRU is configured to act as a helper WTRU to relay data between a base station and another WTRU by communicating with the base station via a traditional radio link and communicating with the other WTRU via a radio cross link.

3. The WTRU of claim 2, wherein the AT policy unit is further configured to:
de-activate the AT application,
control the WTRU to listen for direct WTRU-to-WTRU connection requests from other WTRUs while the AT application is de-activated, wherein the direct WTRU-to-WTRU requests are requests for the WTRU to act as the helper WTRU to relay data for the other WTRUs, and
on a condition that the WTRU receives a connection request from one of the other WTRUs with respect to relaying data for an emergency call, re-activate the AT application to enable the WTRU to relay data for the one of the other WTRUs with respect to completing the emergency call.

4. The WTRU of claim 2, wherein the AT policy unit is further configured to:
receive a cell load level from the base station,
compare the cell load level received from the base station with a cell loading threshold AT_CellLoadThreshold_Parameter %, and
de-activate the AT application on a condition that the cell load level received from the base station is lower than AT_CellLoadThreshold_Parameter %.

5. The WTRU of claim 2, wherein the AT policy unit is further configured to:
receive a direct WTRU-to-WTRU connection request from the other WTRU,
determine whether the WTRU is connected to a closed subscriber group (CSG) cell,
determine whether the other WTRU subscribes to the CSG,
on a condition that the other WTRU does not subscribe to the CSG, determine whether an AT policy stored in the memory prevents the WTRU from acting as a helper node to relay data for a WTRU that does not subscribe to the CSG, and
on a condition that an AT policy stored in the memory prevents the WTRU from acting as a helper WTRU to relay data for a WTRU that does not subscribe to the CSG and the other WTRU does not subscribe to the CSG, deny the direct WTRU-to-WTRU connection request.

6. The WTRU of claim 2, wherein the AT policy unit is further configured to:
determine whether a policy is stored in the memory imposing a lawful intercept policy for the WTRU, and
on a condition that a policy is stored in the memory imposing a lawful intercept policy for the WTRU, controlling the WTRU to route all data through the base station when acting as a helper WTRU to forward data between the base station and the other WTRU.

7. The WTRU of claim 2, wherein the AT policy unit is further configured to:
determine whether a policy is stored in the memory imposing a location services policy for the WTRU, and
on a condition that a policy is stored in the memory imposing a location services policy for the WTRU and the WTRU is acting as a helper WTRU to relay data for another WTRU with respect to a service that requires location information for the other WTRU, using a location of the WTRU as a location of the other WTRU with respect to the location information for the other WTRU.

8. The WTRU of claim 1, wherein the AT mode of operation is an AT local offload (AT-LO) mode of operation in which the WTRU is configured to offload data and receive an offload of data from another WTRU via direct WTRU-to-WTRU communications.

9. The WTRU of claim 8, wherein the AT policy unit is further configured to:
determine whether a policy is stored in the memory imposing a charging policy on the WTRU with respect to the AT-LO AT mode of operation,
on a condition that a policy is stored in the memory imposing a charging policy on the WTRU with respect to the AT-LO AT mode of operation, control the WTRU to report an amount of traffic sent and received by the WTRU per quality of service (QoS) class.

10. The WTRU of claim 1, wherein:
the WTRU further comprises a battery, and
the AT policy unit is further configured to:
receive a battery charge level from the battery,
compare the battery charge level received from the battery with a battery life threshold level AT_Threshold %, and
on a condition that the battery charge level received from the battery is lower than AT_Threshold %, de-activate the AT application.

11. The WTRU of claim 1, wherein the AT policy unit is further configured to:
receive a user input directing the AT policy unit to de-activate the AT application,
de-activate the AT application in response to receiving the user input directing the AT policy unit to de-activate the AT application, and
re-activate the AT application in response to at least one of:
a set period of time elapsing after the AT policy unit received the user input directing the AT policy unit to de-activate the AT application,
the WTRU is power cycled,
the WTRU receives a broadcast that is on a defined list of broadcasts, or
an over-the-air (OTA) software upgrade is requested.

12. The WTRU of claim 1, wherein the AT policy unit is further configured to:
determine whether a preferred public land mobile network (PLMN) is available for connection to the WTRU,
on a condition that the preferred PLMN is not available for connection to the WTRU, send a connection request for direct WTRU-to-WTRU communications to another WTRU, wherein:
the connection request for direct WTRU-to-WTRU communications is a request for the other WTRU to act as a helper WTRU to relay data between a base station and the WTRU by communicating with the base station via a traditional radio link and communicating with the WTRU via a radio cross link, and
the WTRU is not located within a cell operated by the base station.

13. The WTRU of claim 1, wherein the memory is at least one of persistent memory areas of the WTRU or a universal mobile telecommunications subscriber identification module (USIM).

14. A wireless transmit/receive unit (WTRU) configured to communicate directly with at least one other WTRU in an advanced topology (AT) mode of operation comprising:
a central processing unit (CPU) configured to control an AT application to run the AT mode of operation, wherein the AT mode of operation is an AT relay (AT-R) mode in which the WTRU is configured to request that another WTRU act as a helper WTRU to relay data between a base station and the WTRU by communicating with the base station via a traditional radio link and communicating with the WTRU via a radio cross link; and
an advanced topology (AT) policy unit that is separate from the CPU and is configured to:
determine whether a policy is stored in the WTRU that imposes a security and privacy policy on the WTRU with respect to a particular AT-Barred application, and
on a condition that a policy is stored in the memory imposing a security and privacy policy on the WTRU with respect to the particular AT-Barred application, controlling the WTRU to relay data related to the particular AT-Barred application via the traditional radio link only.

15. A method of a wireless transmit/receive unit (WTRU) communicating directly with at least one other WTRU in a plurality of advanced topology (AT) modes of operation, the method comprising:
the WTRU receiving at least one AT policy from a network entity;
the WTRU storing the at least one AT policy in a memory of the WTRU;
the WTRU activating and de-activating at least one AT application that runs at least one of the plurality of AT modes of operation based on the at least one AT policy stored in the memory;
the WTRU receiving data from at least one application within the WTRU other than the at least one AT application; and
the WTRU controlling the at least one application within the WTRU other than the AT application based on the at least one AT policy.

16. The method of claim 15, wherein the plurality of AT modes of operation include at least:
an AT relaying (AT-R) mode in which the WTRU is configured to act as a helper WTRU to relay data between a base station and another WTRU by communicating with the base station via a traditional radio link and communicating with the other WTRU via a radio cross link, and
an AT local offload (AT-LO) mode in which the WTRU is configured to offload data and receive an offload of data from another WTRU via direct WTRU-to-WTRU communications.

17. The method of claim 16, further comprising:
the WTRU receiving a battery charge level from a battery of the WTRU;
the WTRU comparing the battery charge level received from the battery with a battery life threshold level AT_Threshold %; and
the WTRU de-activating the at least one AT application on a condition that the battery charge level received from the battery is lower than AT_Threshold %.

18. The method of claim 16, further comprising:
the WTRU receiving a user input directing the WTRU to de-activate at least one of the plurality of AT modes of operation;
the WTRU de-activating the at least one of the plurality of AT modes of operation in response to the WTRU receiving the user input directing the WTRU to de-activate the at least one of the plurality of AT modes of operation; and
the WTRU re-activating the at least one of the plurality of AT modes of operation in response to at least one of:
a set period of time elapsing after the WTRU received the user input directing the WTRU to de-activate the at least one of the plurality of AT modes of operation,
the WTRU is power cycled,
the WTRU receives a broadcast that is on a defined list of broadcasts, or
an over-the-air (OTA) software upgrade is requested.

19. The method of claim 16, further comprising:
the WTRU de-activating at least one of the plurality of AT modes of operation,
the WTRU controlling the WTRU to listen for direct WTRU-to-WTRU connection requests from other WTRUs while the at least one of the plurality of AT modes of operation is de-activated, wherein the direct WTRU-to-WTRU requests are requests for the WTRU to act as the helper WTRU to relay data for the other WTRUs, and
the WTRU re-activating the at least one of the plurality of AT modes of operation to enable the WTRU to relay data for the one of the other WTRUs with respect to completing an emergency call on a condition that the WTRU receives a connection request from one of the other WTRUs with respect to relaying data for the emergency call.

20. The method of claim 16 further comprising:
the WTRU receiving a cell load level from the base station;
the WTRU comparing the cell load level received from the base station with a cell loading threshold AT_CellLoadThreshold_Parameter %; and
the WTRU de-activating at least one of the plurality of AT modes of operation on a condition that the cell load level received from the base station is lower than AT_CellLoadThreshold_Parameter %.
